(19) United States
(12) Patent Application Publication
(10) Pub. No.: US 2026/0097583 A1
(43) Pub. Date: Apr. 9, 2026

(54) LIQUID EJECTION APPARATUS, LIQUID EJECTION HEAD CONTROL DEVICE, AND LIQUID EJECTION HEAD CONTROL METHOD

(71) Applicant: CANON KABUSHIKI KAISHA, Tokyo (JP)

(72) Inventors: YASUNORI NIN, Kanagawa (JP); KAZUKI HIROBE, Tokyo (JP)

(21) Appl. No.: 19/339,812

(22) Filed: Sep. 25, 2025

(30) Foreign Application Priority Data
Oct. 8, 2024 (JP) 2024-176652

(51) Int. Cl. B41J 2/045; B41J 2/175

(52) U.S. Cl. CPC B41J 2/04596; B41J 2/04541; B41J 2/04543; B41J 2/04573; B41J 2/0458; B41J 2/17596; B41J 2202/12

(57) ABSTRACT

A liquid ejection head includes ejection drive elements for driving ejection energy generation elements based on ejection data and circulation drive elements for driving circulation energy generation elements based on circulation data. A liquid ejection head control unit includes a unit configured to generate the ejection data based on image data and a generation unit configured to generate the circulation data based on the ejection data, the circulation data being such that in a case where an ejection drive element does not drive the ejection energy generation element corresponding to the ejection drive element within an inspection zone defined in the ejection data and shifted in the scanning direction, the circulation drive element corresponding to the ejection drive element drives the circulation energy generation element corresponding to the circulation drive element in a drive zone included in the inspection zone.

### BACKGROUND

### Field of the Technology

The present disclosure relates to a liquid ejection apparatus configured to eject liquid to a printing medium or the like, a liquid ejection head control device configured to control a liquid ejection head of the liquid ejection apparatus, and a liquid ejection head control method for controlling the liquid ejection head of the liquid ejection apparatus.

### Description of the Related Art

In a liquid ejection head of a liquid ejection apparatus, ink in a pressure chamber is ejected from an ejection port (also referred to as a "nozzle") using energy generated by an ejection energy generation element. In such a liquid ejection head, a volatile component in the ink may evaporate through the ink-ejecting ejection port, thickening the ink in the ejection port. Such ink thickening may change the ink ejection speed and the like and lead to an ejection failure, including ink landing inaccuracy. Increase in the viscosity of ink is notable especially in a case where an ink ejection operation has a long idle time, and solids in the ink adhere to the inside of the ejection port, increasing ink flow resistance and causing an ink ejection failure more likely to occur. One of known measures against such a liquid thickening phenomenon is a method involving passing fresh liquid through the ejection port in the pressure chamber. One method for passing liquid is to circulate the liquid inside the head by utilizing a pressure difference caused by a main-body-side pump provided separately from a fluid die for ejection. Another known method is to circulate ink by utilizing a circulation energy element disposed at the fluid die itself (see Japanese Patent Laid-Open No. 2019-18584).

With the on-demand circulation disclosed in Japanese Patent Laid-Open No. 2019-18584, in a case where a liquid jetting element corresponding to an ejection energy generation element is not driven for a certain period of time, a fluid circulation element corresponding to a circulation energy generation element is driven. However, the fluid circulation element is driven for a limited period of time only immediately before the next driving of the fluid jetting element. Thus, liquid circularity cannot be necessarily maintained.

### SUMMARY

The present invention has been made in view of the above problem and aims to prevent liquid circularity from lowering in a case where an ejection energy generation element is not driven.

Features of the present disclosure will become apparent from the following description of embodiments with reference to the attached drawings. The following description of embodiments are described by way of example.

### BRIEF DESCRIPTION OF THE DRAWINGS

FIG. 1A is a perspective view schematically showing a liquid ejection apparatus.

FIG. 1B is a perspective view schematically showing the liquid ejection apparatus.

FIG. 2A is a schematic diagram illustrating details of an area around an ejection port of a liquid ejection head.

FIG. 2B is a schematic diagram illustrating details of the area around the ejection port of the liquid ejection head.

FIG. 2C is a schematic diagram illustrating details of the area around the ejection port of the liquid ejection head.

FIG. 3A is an exploded perspective view showing the liquid ejection head.

FIG. 3B is a plan view of a liquid ejection chip.

FIG. 3C is a plan view of liquid ejection chips.

FIG. 3D is a plan view of liquid ejection chips.

FIG. 4 is a functional block diagram showing an example configuration of the liquid ejection head.

FIG. 5 is a functional block diagram showing the configuration of the liquid ejection apparatus.

FIG. 6 is a timing chart for illustrating an operation by a timing generation unit.

FIG. 7 is a functional block diagram showing the configuration of a liquid ejection head control unit.

FIG. 8 is a timing chart showing signals generated by the liquid ejection head control unit.

FIG. 9 is a functional block diagram of part of the liquid ejection apparatus according to a first embodiment.

FIG. 10 is a functional block diagram of a pump timing calculation unit of the first embodiment.

FIG. 11 is a functional block diagram of a pump flag signal generation unit according to the first embodiment and a third embodiment.

FIG. 12 is a diagram showing data stored in memory according to the first embodiment.

FIG. 13 is a diagram illustrating a pump timing calculation method.

FIG. 14 is a diagram illustrating a pump timing calculation method according to the first and third embodiments.

FIG. 15 is a diagram illustrating grouping of nozzles.

FIG. 16 is a diagram showing the relationship of FIGS. 16A and 16B.

FIG. 16A is flowchart showing an operation by the pump timing calculation unit.

FIG. 16B is flowchart showing an operation by the pump timing calculation unit.

FIG. 17 is a timing chart of pump flag timing calculation according to the first and third embodiments.

FIG. 18 is a functional block diagram of part of a liquid ejection apparatus according to a second embodiment.

FIG. 19 is a functional block diagram of a pump timing calculation unit according to the second embodiment.

FIG. 20 is a functional block of a pump flag signal generation unit according to the second embodiment.

FIG. 21 is a diagram showing data stored in memory according to the second embodiment.

FIG. 22 is a diagram illustrating a pump timing calculation method according to the second embodiment.

FIG. 23A is a timing chart of pump flag timing calculation according to the second embodiment.

FIG. 23B is a timing chart of pump flag timing calculation according to the second embodiment.

FIG. 24 is a functional block diagram of part of a liquid ejection apparatus according to the third embodiment.

FIG. 25 is a diagram showing data stored in memory according to the third embodiment.

FIG. 26 is a diagram illustrating an example.

### DESCRIPTION OF THE EMBODIMENTS

Preferred embodiments of the present disclosure are described in detail below with reference to the drawings attached hereto. Note that the embodiments below are not provided to limit the matters of the present disclosure, and not all the combinations of features described in the present embodiments are necessarily essential as solutions provided by the present disclosure. Note that the same reference numerals are used to denote the same constituents. The following first describes the basic configuration of the present disclosure and then describes characteristics of the present disclosure.

### First Embodiment

### Constituents of a Circulation Unit

### Liquid Ejection Apparatus

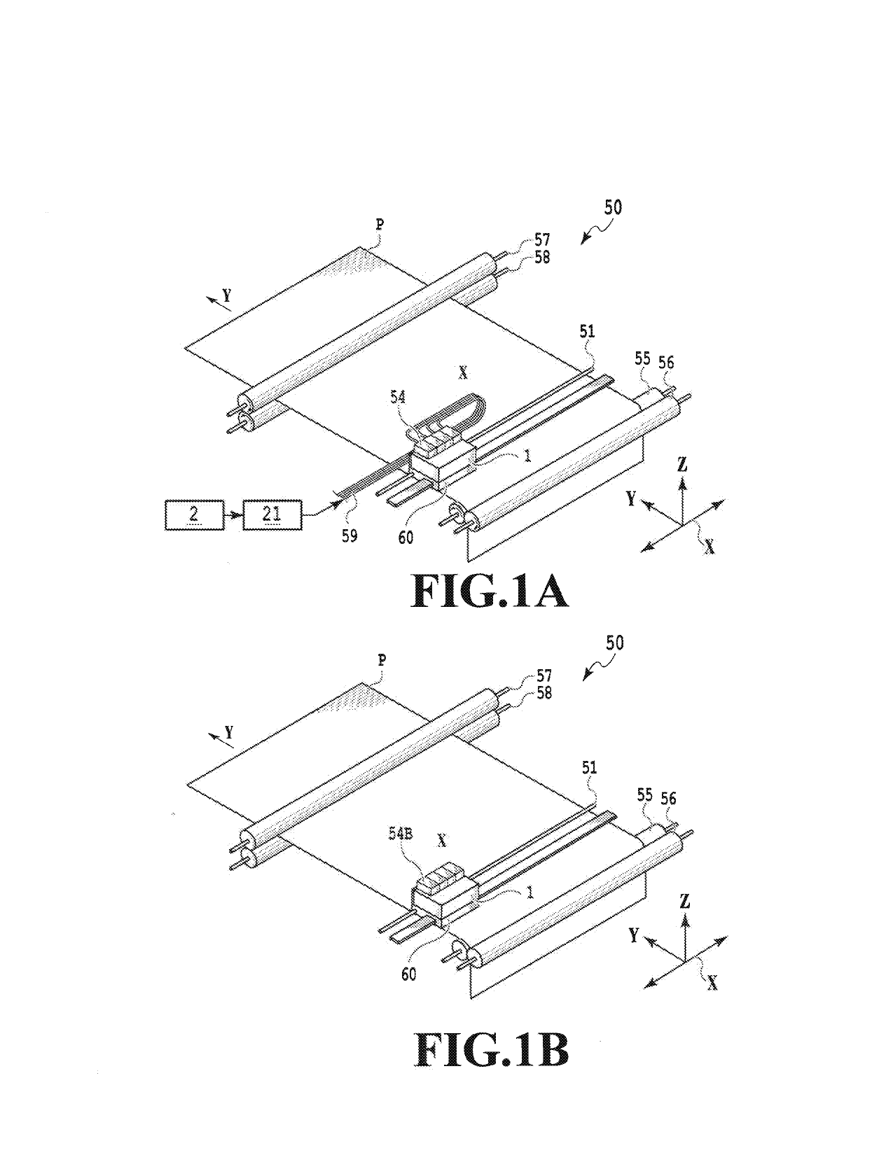

First, an overall configuration of a liquid ejection apparatus 50 of the present embodiment is described. FIGS. 1A and 1B are perspective views schematically showing two types of liquid ejection apparatus.

The liquid ejection apparatus 50 depicted in FIGS. 1A and 1B is a liquid ejection apparatus (serial-type liquid ejection apparatus) designed to print an image by ejecting liquid to a printing medium P using a liquid ejection head configured to scan in a direction intersecting with a direction in which the printing medium P is conveyed. The present disclosure is not limited to a serial-type liquid ejection apparatus. The present disclosure can also be applied to a page-wide liquid ejection apparatus designed to print an image by ejecting liquid to a printing medium conveyed in the conveyance direction using a line head (page-wide head) elongated in the width direction of the printing medium. Note that the liquid ejection head of the present embodiment can eject four types of ink, black (K), cyan (C), magenta (M), and yellow (Y), and can print a full color image using these inks. The inks that the liquid ejection head can eject are not limited to the four inks described above. The present disclosure can also be applied to a liquid ejection head for ejecting other types of ink. Thus, there are not limitations on the types of ink to be ejected from the liquid ejection head and on the number of types of ink.

In the serial-type liquid ejection apparatus 50, a liquid ejection head 1 is carried by a carriage 60. The carriage 60 reciprocates along a guide shaft 51 extending in a main scanning direction (an X-direction). A printing medium is conveyed in a sub scanning direction (a Y-direction) intersecting with (in the present example, orthogonal to) the main scanning direction by conveyance rollers (conveyance units) 55, 56, 57, and 58. Note that in the drawings referred to below, the Z-direction is the vertical direction and intersects with (in the present example, orthogonal to) an X-Y plane defined by the X-direction and the Y-direction.

FIG. 1A shows a configuration where main ink tanks 2 are provided outside the liquid ejection head as liquid storage units. A liquid (ink) stored in each ink tank 2 is supplied to a corresponding sub ink tank 54 on the liquid ejection head 1 side via an ink supply tube (liquid communication channel) 59 and the like by the driving force of an external pump 21. By contrast, FIG. 1B shows a configuration where ink tanks 54B are provided immediately above the liquid ejection head 1 instead of the main ink tanks 2 being provided outside the liquid ejection head as liquid storage units. In the configuration in FIG. 1B, the liquid ejection head 1 may be provided integrally with the ink tanks 54B and configured to be attachable to and detachable from the carriage 60. Also, the liquid ejection head 1 may be provided integrally with the carriage 60, and only the ink tanks 54B may be configured to be attached and detached. The following uses the configuration in FIG. 1A as a representative example.

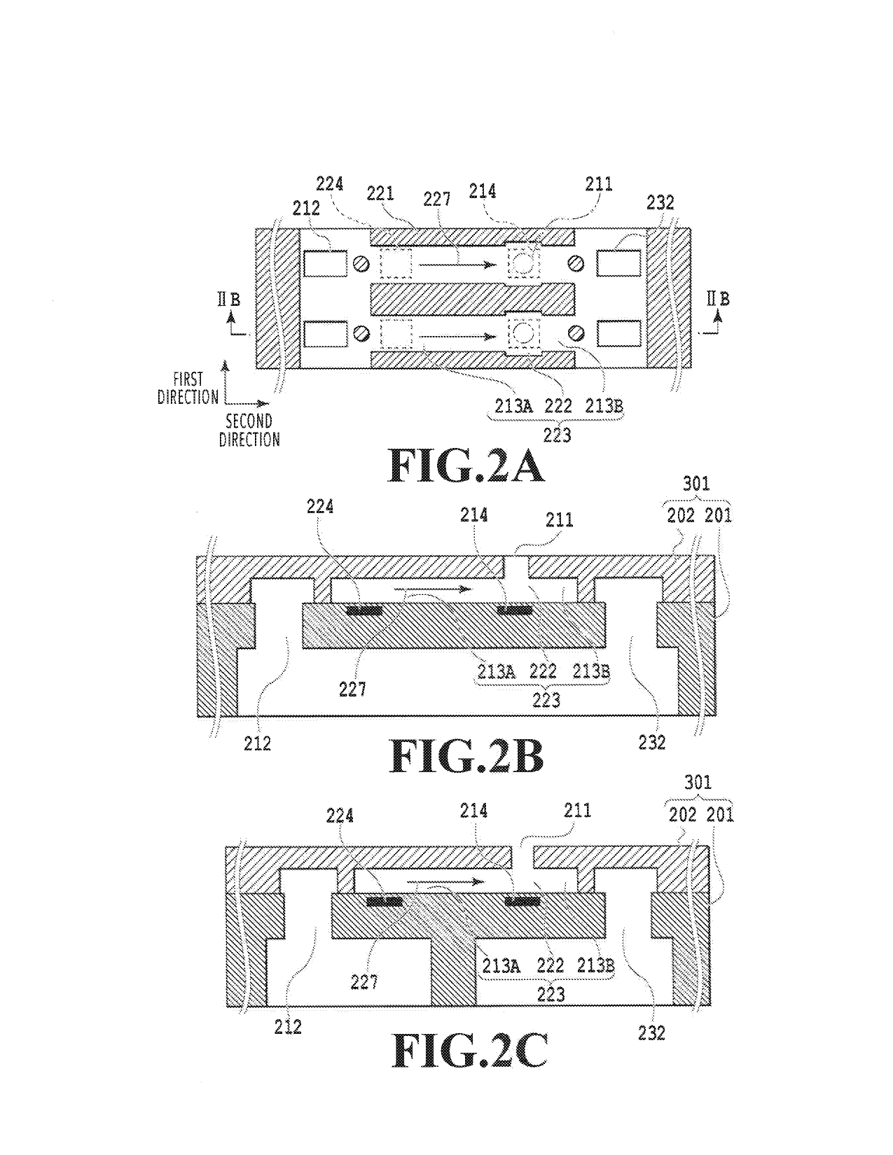

The liquid ejection head 1 is configured including individual ejection units to be described later. Although a specific configuration will be described later, as shown in FIGS. 2A to 2C, an individual ejection unit is provided with an ejection port 211 for ejecting liquid and a pressure chamber 222 communicating with the ejection port 211. The individual ejection unit is provided with a first energy generation element (an ejection energy generation element) 214 provided in the pressure chamber 222 and configured to generate energy for ejecting liquid from the ejection port 211. The individual ejection unit is provided with an individual flow channel 223 communicating with the pressure chamber 222 and a second energy generation element (a circulation energy generation element) 224 provided in the individual flow channel 223. The liquid ejection head 1 has a plurality of individual ejection units and has a supply flow channel for supplying liquid to the individual flow channels in the individual ejection units.

For usage of the liquid ejection head, various measures are taken to prevent instable liquid ejection which may occur due to, e.g., evaporation of a volatile component such as moisture from the ejection port or solid content concentration near the ejection port caused as a result of the evaporation. For example, the liquid ejection apparatus may be provided with a cap member (not shown) disposed at a position offset in the X-direction from the printing medium's conveyance path to be able to cover the ejection port surface of the liquid ejection head where ejection ports are formed. The cap member covers the ejection port surface of the liquid ejection head to prevent the ejection ports from drying and to protect the ejection ports while, for example, a print operation is not performed. Further, an ink suction mechanism (not shown) can be provided, in which case the cap member is used for, e.g., an operation to suction ink from the ejection ports. Performing this ink suction operation can refresh ink near the ejection ports and maintain the quality of an image printed. Also, a method is known where while no print operation is performed, ejection called preliminary ejection (pre-ejection) is performed to discard concentrated ink. In another known method, preliminary ejection (on-page preliminary ejection or in-page preliminary ejection) is performed during a print operation to eject an inconspicuous amount of ink to an inconspicuous position on a printing medium in terms of image quality. These methods greatly contribute to improvement in image quality, but discards part of the ink to refresh the ejection ports. Thus, what is desired is to refresh the ejection ports while wasting as little ink as possible.

To address such a challenge, the provision of the second energy generation element (circulation energy generation element) 224 in the individual flow channel to circulate ink in the individual flow channel can reduce drying of the ejection port and ink concentration near the ejection port while reducing the amount of wasted ink. More specifically, the number of times preliminary ejection or suction recovery is performed can be reduced as much as possible. Reducing the number of preliminary ejection or the like as much as possible can lead to improved throughput or yield.

The circulation energy generation element 224 does not need to be provided in all the individual ejection units of the liquid ejection head. The above-described advantageous effect can be achieved as long as the circulation energy generation element 224 is provided in some of the individual ejection units compared to a case where the circulation energy generation element 224 is provided in none of them.

Also, the liquid ejection head shown in FIG. 1A may be configured including the circulation energy generation element 224 at all the locations corresponding to the four types of ink or may be configured including the circulation energy generation element 224 only at locations corresponding to one type of ink. In other words, the liquid ejection head may be configured to circulate not all the four types of ink, but only at least one of the types of ink.

### Basic Configuration of the Liquid Ejection Head

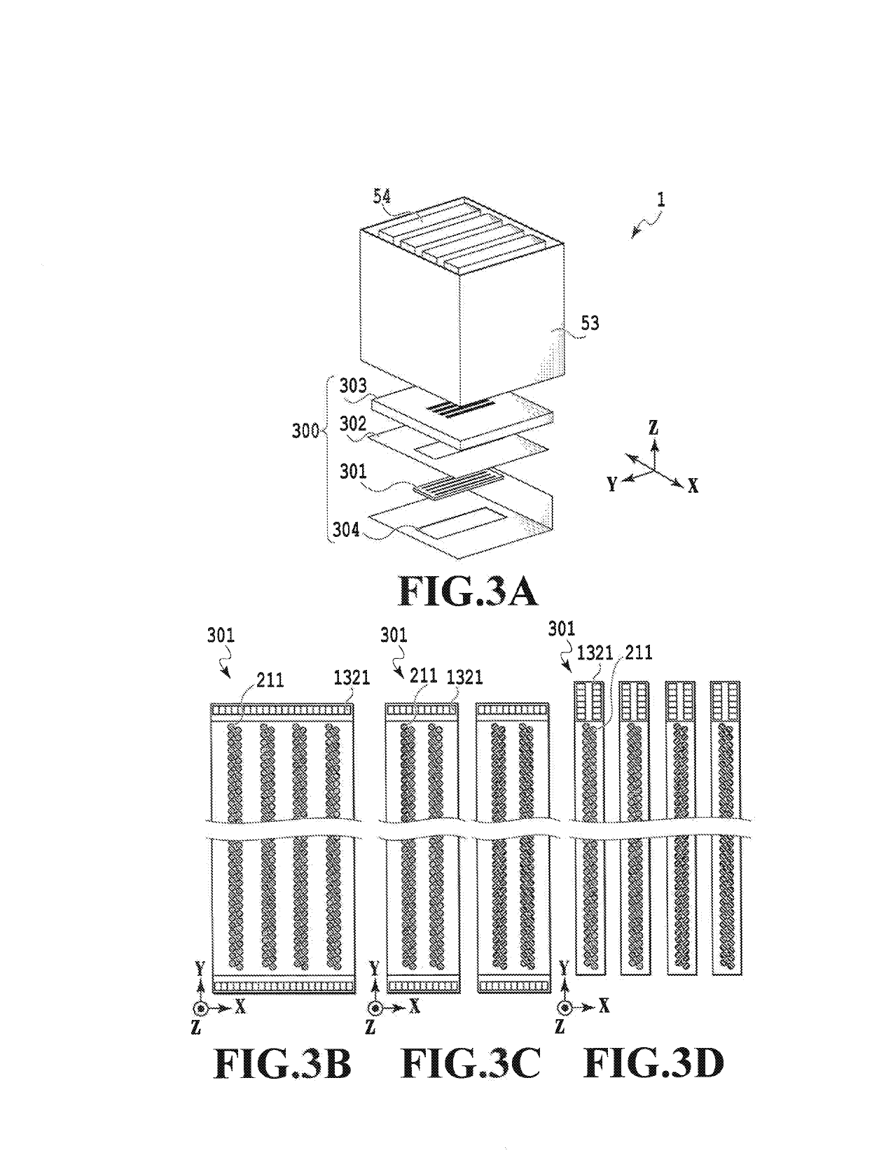

FIG. 3A is an exploded perspective view of the liquid ejection head of the present embodiment. As shown in FIG. 3A, the liquid ejection head 1 is configured including the sub ink tanks 54 configured to store ink temporarily in the head and a liquid ejection chip 301 for ejecting ink supplied from the sub ink tanks 54 to the printing medium P. The liquid ejection head 1 of the present embodiment is fixed to and supported on the carriage 60 of the liquid ejection apparatus 50 by a positioning unit and an electrical contact (not shown) provided at the carriage 60. The liquid ejection head 1 prints on the printing medium P by ejecting ink while moving along with the carriage 60 in the main scanning direction (the X-direction) shown in FIG. 1A.

Note that as shown in FIG. 3A, the liquid ejection head 1 includes an ejection unit 300. Then, the ejection unit 300 is configured including a first support member 303, a second support member 302, the liquid ejection chip 301, and an electric wiring member (electric wiring tape) 304.

The external pumps 21 connected to the ink tanks 2 as ink supply sources are provided with the ink supply tubes 59 (see FIG. 1A). A liquid connector (not shown) is provided at the tip end of each of the ink supply tubes 59. In attachment of the liquid ejection head 1 to the liquid ejection apparatus 50, the liquid connectors provided at the tip ends of the ink supply tubes 59 are connected in a liquid tight manner to liquid-connector insertion ports provided as liquid inlets at a head casing 53 of the liquid ejection head 1. As a result, ink supply channels are formed, extending from the ink tanks 2 to the liquid ejection head 1 through the external pumps 21. In the present embodiment where four types of ink are used, four sets of the ink tank 2, the external pump 21, the ink supply tube 59, and the sub ink tank 54 are provided in correspondence to the respective types of ink, and four ink supply channels in correspondence to the inks are formed independently. In this way, the liquid ejection apparatus 50 of the present embodiment has an ink supply system for supplying ink from the ink tanks 2 provided outside of the liquid ejection head 1. Note that the liquid ejection apparatus 50 of the present embodiment does not have an ink collection system for collecting ink in the liquid ejection head 1 into the ink tanks. Thus, the liquid ejection head 1 is provided with the liquid-connector insertion ports to which to connect the ink supply tubes 59 from the ink tanks 2, but not with connector insertion ports to which to connect tubes for collecting ink in the liquid ejection head 1 into the ink tanks 2. Note that the liquid connector insertion ports are provided for the respective inks.

FIGS. 3B, 3C, and 3D are plan views of the liquid ejection chip 301 forming the liquid ejection head, as seen from the ejection surface side. FIG. 3B shows a configuration where one chip supports four colors, FIG. 3C shows a configuration where one chip supports two colors, and FIG. 3D shows a configuration where one chip supports one color. Each liquid ejection chip 301 is provided with pads 1321 used for electric implementation of the ejection ports 211. FIG. 3A shows the one-chip configuration in FIG. 3B.

FIG. 3B shows a configuration where one chip supports four colors. The four colors are, for example, black, cyan, magenta, and yellow, which are assigned to the respective arrays extending in the Y-direction. In the example shown in FIG. 3B, the ejection ports for each color are disposed in two rows extending in the Y-direction in a staggered manner. Note that the ejection ports are arrayed at a constant pitch in the Ydirection. The ejection ports for each color may be arrayed in one row in the Y-direction. Also, only the ejection ports for black may be arrayed in two rows, with the ejection ports for each of the other colors being arranged in one row. In this case, there are five rows in total.

FIG. 3C shows a configuration with two chips each being allocated two colors. In this case, two chips may be mounted on a single liquid ejection head, or one chip may be mounted on a single liquid ejection head to have two heads.

FIG. 3D shows a configuration with four chips each being allocated one color. In this case, four chips may be mounted on a single liquid ejection head, or one chip may be mounted on a single liquid ejection head to have four heads. Further, two chips may be mounted on a single liquid ejection head to have two heads.

Also, in the configurations with two or more separated chips like in FIGS. 3C and 3D, not all the chips necessarily have to have the same length. Also, any combinations of the colors may be allocated to the plurality of chips. The same applies to a case where there are four or more colors in total (simple straight type).

FIGS. 2A to 2C are schematic diagrams giving a detailed illustration of an area near the ejection ports of the liquid ejection head configured to eject liquid such as ink. FIG. 2A is a plan view seen from a direction in which a liquid droplet is ejected from an ejection port. FIG. 2B is a sectional view of a first configuration taken along line IIB-IIB in FIG. 2A. FIG. 2C is a sectional view of a second configuration taken along line IIB-IIB in FIG. 2A.

In FIGS. 2A to 2C, the pressure chambers 222 and the individual flow channels 223 are formed between a print element substrate 201 and an orifice plate 202. The pressure chambers 222 are each partitioned by partitioning walls 221 and are provided in correspondence to the respective ejection ports 211, and ink is passed through each of the pressure chambers 222 through the corresponding individual flow channel 223. A meniscus is formed at ink in the ejection port 211, forming an ejection port interface which is the interface between ink and atmosphere.

The print element substrate 201 includes the ejection energy generation elements 214 configured to generate energy for ejecting ink in the pressure chambers. In the present example, thermoelectric conversion elements are used as the ejection energy generation elements 214. Each ejection energy generation element 214 is closer in position to a second opening (flow-out opening) 232 than to a first opening (supply opening) 212, and so are the positions of the ejection port 211 and the pressure chamber 222. The ejection energy generation element 214 is driven and heated up to form a bubble in ink in the pressure chamber 222, which enables ink to be ejected from the ejection port 211 by use of the energy of the bubble thus formed. The ejection energy generation elements 214 are not limited to thermoelectric conversion elements like in the present example, and piezoelectric elements or the like can be used as well. The print element substrate 201 also has the circulation energy generation elements 224 each configured to generate energy for generating an ink circulation flow 227 in the individual flow channel as indicated by the arrow. In the present example, thermoelectric conversion elements are used as the circulation energy generation elements 224. Each circulation energy generation element 224 is closer in position to the first opening 212 than to the second opening 232.

The individual flow channel 223 extends in a second direction intersecting with (in the present example, orthogonal to) an array of ejection ports arranged in a first direction. The individual flow channel 223 includes the pressure chamber 222, a FIG. 2B inlet (upstream)-side connection flow channel 213A communicating with one of end portions of the pressure chamber 222, and a FIG. 2B outlet (downstream)-side flow channel 213B communicating with the other end portion of the pressure chamber 222. The individual flow channel 223, at its respective sides, communicates with the first opening 212 and the second opening 232 penetrating the print element substrate 201. Thus, in FIGS. 2A, 2B, and 2C, the connection flow channels 213A are located leftward of the ejection port array. The connection flow channels 213B are located rightward of the ejection port array. Both end portions of the individual flow channels 223 are located at positions opposite from each other with the ejection port array interposed in between.

The flow of ink through the individual flow channel 223 is roughly classified into the following two.

(1) The flow of ink for refill after ink ejection, caused by driving of the first energy element 214

(2) The flow of ink for formation of a circulation flow, caused by driving of the second energy element 224

In the event where the first energy element 214 is driven to eject liquid from the ejection port 211, ink flows in from the first opening 212 and the second opening 232 to supply ink for ejection.

In the event where the second energy element 224 is driven to form a circulation flow, ink flows into the individual flow channel 223 through the first opening 212 which is at the connection flow channel side and then flows out through the second opening 232 which is not at the connection flow channel side. In the present example, ink flowing out through the second opening 232 is returned to the first opening 212 and circulated to form the circulation flow 227 in the individual flow channel 223 as indicated by the arrow.

Note that FIG. 2B shows a configuration where the first opening 212 and the second opening 232 are connected to the individual flow channel 223 and unified outside the liquid ejection head, and FIG. 2C shows a configuration where the first opening 212 and the second opening 232 are not unified inside the chip. Either one of these configurations may be employed.

A filter for removing foreign matter in ink may be provided in the ink circulation flow channels inside and outside the liquid ejection head 1. For example, a filter may be disposed at the outer sides of the individual flow channel 223, i.e., the flow in side and the flow-out side. Also, a filter may be disposed in the individual flow channel 223 at a location between the ejection energy generation element 214 and the circulation energy generation element 224. In this case, no filter needs to be disposed at the upstream side (the circulation energy generation element 224 side) which is the outer side of the individual flow channel 223.

### Driving Mechanism of the Present Embodiment: Toggle Drive

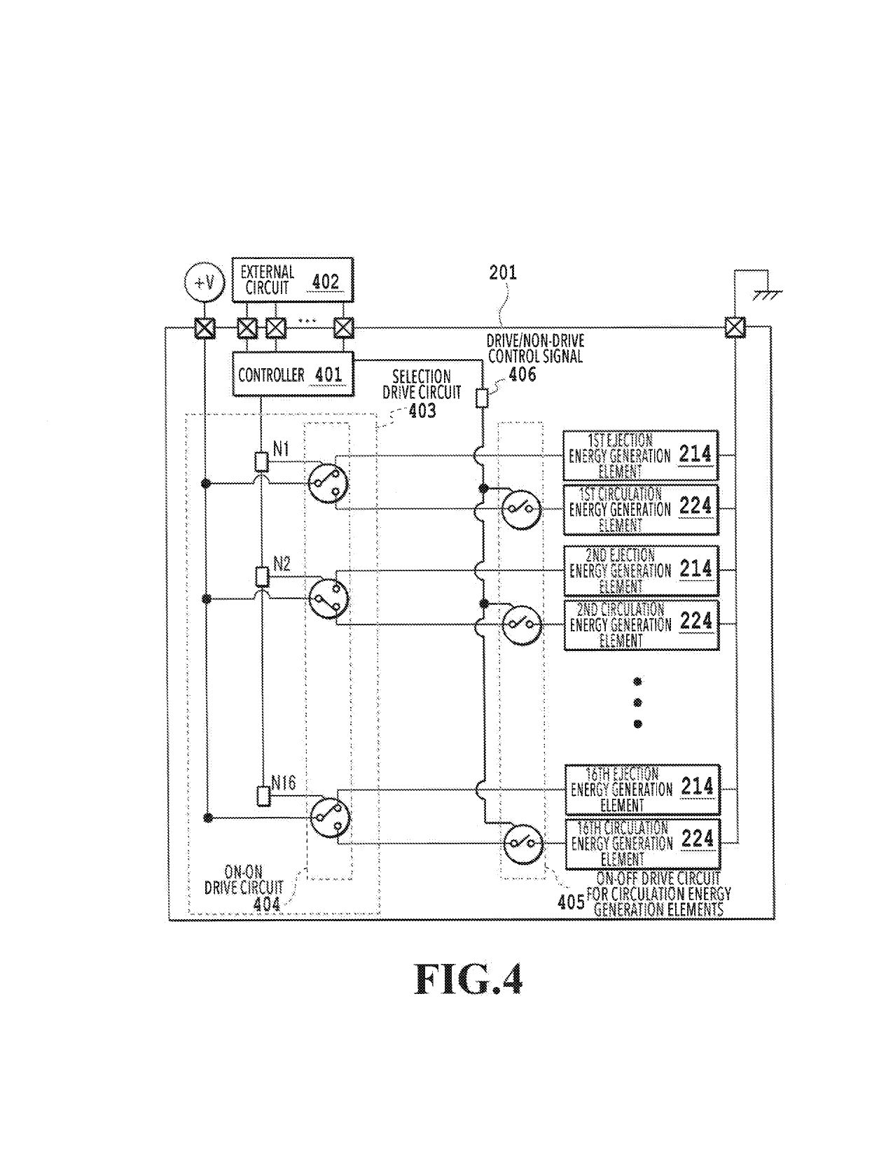

In the present embodiment, a selection drive circuit 403 shown in FIG. 4 is formed on the print element substrate 201. A voltage source (+V) and an external circuit 402 provided outside the print element substrate 201 are connected to the selection drive circuit 403 on the print element substrate 201. The selection drive circuit 403 includes an on-on drive circuit 404 configured to turn on and drive either the ejection energy generation element 214 or the circulation energy generation element 224 in response to a control signal for each address (for example, N1 to N16) received from a controller 401. The controller 401 controls a drive pulse for driving the ejection energy generation element 214 or the circulation energy generation element 224 and a time interval of application of the drive pulse to each element. Also, in a case where the on-on drive circuit 404 selects the circulation energy generation element 224, an on-off drive circuit 405 controls driving of the circulation energy generation element 224 according to a drive/non-drive signal 406. In this way, in the present embodiment, driving of the circulation energy generation element 224 is controlled by the on-on drive circuit 404 and the on-off drive circuit 405.

Thus, in a case where the on-on drive circuit 404 selects the ejection energy generation element 214, the ejection energy generation element 214 is driven, and the circulation energy generation element 224 is not driven, irrespective of the drive/non drive signal 406.

In a case where the on-on drive circuit 404 selects the second energy generation element 224, the ejection energy generation element 214 is not driven irrespective of the drive/non-drive signal 406.

In a case where the on-on drive circuit 404 selects the second energy generation element 224, and the drive/non-drive signal 406 turns on the on-off drive circuit 405, the circulation energy generation element 224 is driven.

In a case where the on-on drive circuit 404 selects the second energy generation element 224, and the drive/non-drive signal 406 turns off the on-off drive circuit 405, the circulation energy generation element 224 is not driven. Thus, in a case where the on-on drive circuit 404 selects the second energy generation element 224, and the drive/non-drive signal 406 turns off the on-off drive circuit 405, neither the ejection energy generation element 214 nor the circulation energy generation element 224 is driven.

Thus, driving of the circulation energy generation element 224 is controlled according to drive data for the ejection energy generation element 214 (a control signal for each address received from the controller 401) and the drive/non-drive signal 406. In this way, in the configuration shown in FIG. 4, drive data dedicated for the circulation energy generation element 224 does not need to be provided. This configuration therefore advantageously reduces the quantity of drive data approximately by half compared to a configuration where drive data dedicated for the circulation energy generation element 224 is needed.

It is also possible to collectively control driving of a plurality of circulation energy generation elements 224 based on a common drive/non-drive signal 406. For example, driving of circulation energy generation elements B1 to Bn can be controlled based on a common drive/non-drive signal 406. Note that n is 16 in the example shown in FIG. 4. Thus, one group is formed by ejection energy generation elements Al to A16 and circulation energy generation elements B1 to B16, i.e., a total of 32 elements (16 pairs of elements). Then, on and off of the circulation energy generation elements B1 to B16 are controlled by a drive/non-drive signal 406 common to them. However, n may be changed to a different value. A group includes 16 elements in a case where n is 8, and a group includes 24 elements in a case where n is 12.

Also, while thermoelectric conversion elements or piezoelectric elements can be used as the circulation energy generation elements 224, thermoelectric conversion elements are used in the present embodiment. The direction of the circulation flow is as indicated by the arrow 227. In a case of using piezoelectric elements, the direction of the circulation flow may be opposite from the direction indicated by the arrow 227 depending on the drive mechanism.

The present embodiment shows a configuration where the drive/non-drive signals 406 are introduced to the print element substrate 201 to control driving of the circulation energy generation elements 224. Then, the controller 401, the selection drive circuit 403, and the on-off drive circuit 405 shown in FIG. 4 are formed on the print element substrate 201. However, the present disclosure is not limited to this configuration as long as a portion of the liquid ejection head 1 excluding the print element substrate 201 or a portion of the liquid ejection apparatus 50 excluding the liquid ejection head 1 includes part of or the entirety of a portion for controlling driving of the circulation energy generation elements 224. For example, at least one of the controller 401, the selection drive circuit 403, and the on-off drive circuit 405 may be included in the portion of the liquid ejection head 1 excluding the print element substrate 201 or the portion of the liquid ejection apparatus 50 excluding the liquid ejection head 1.

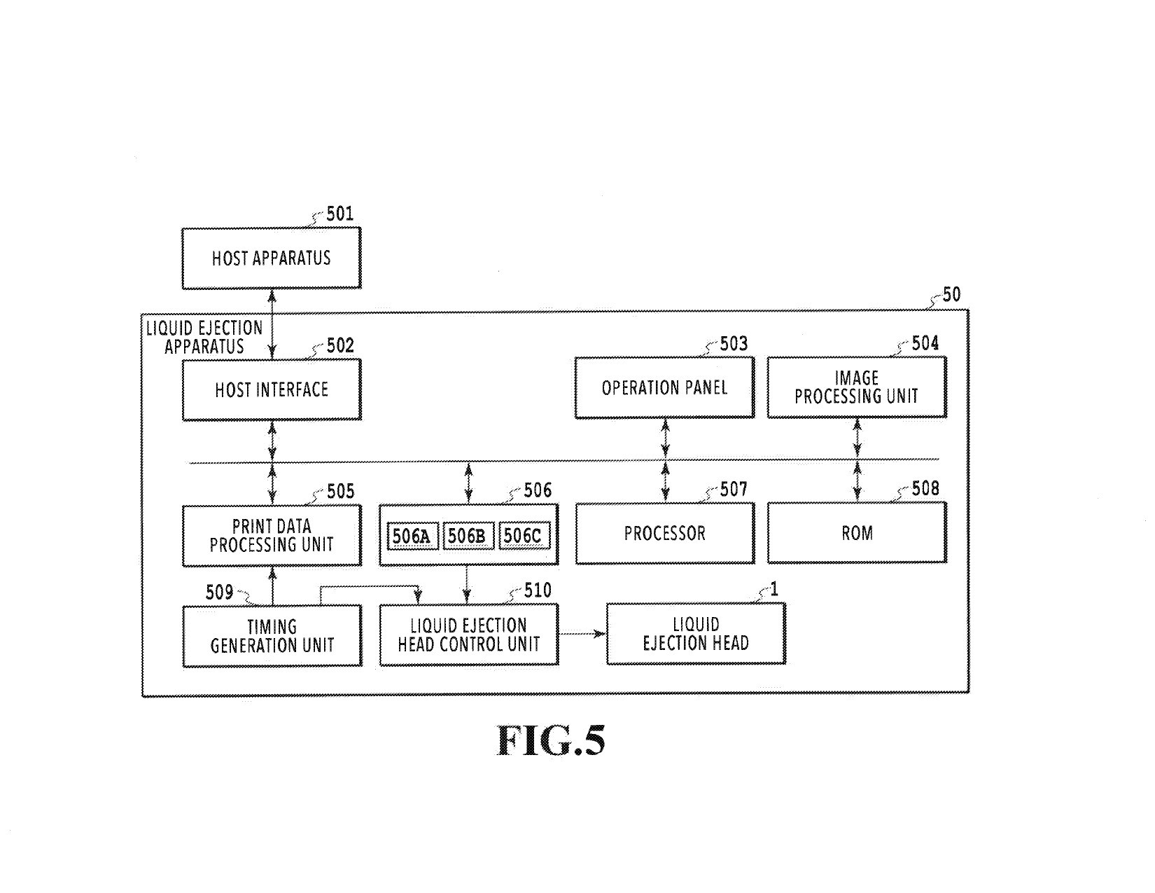

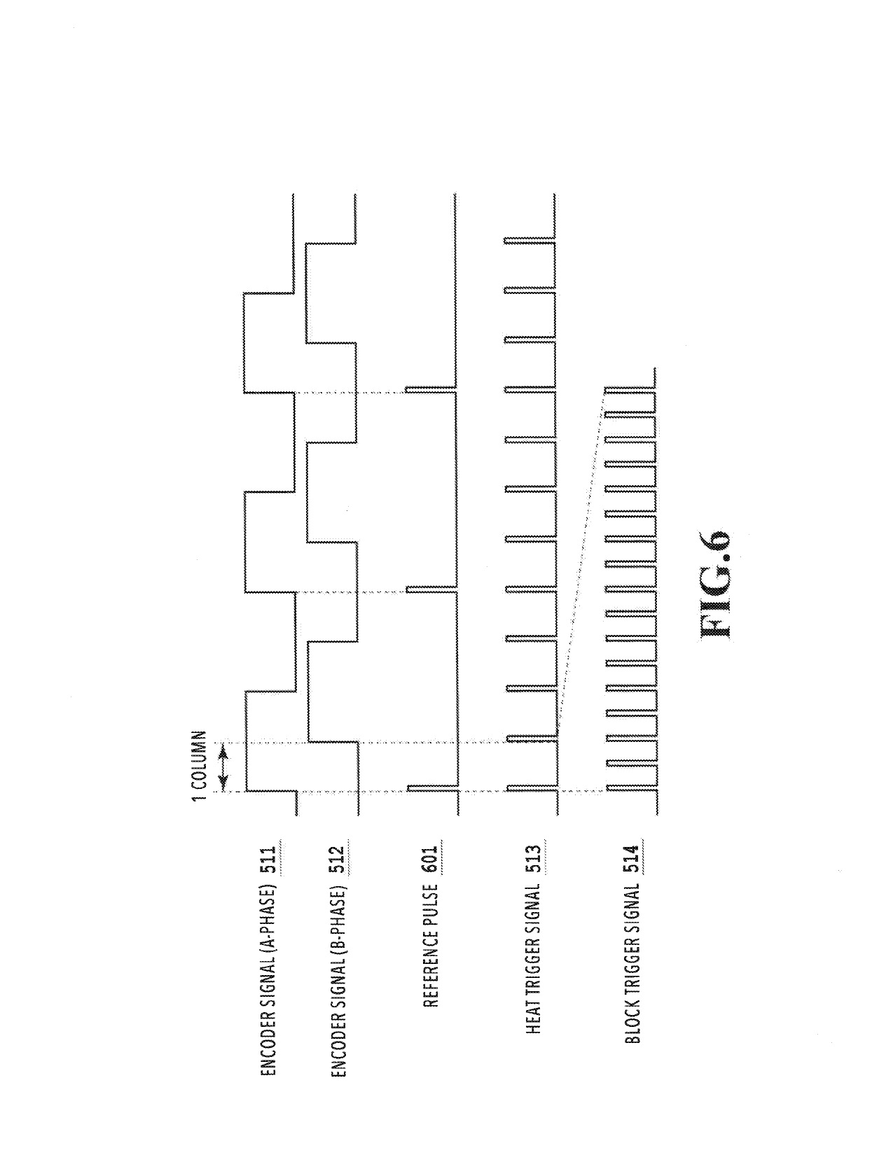

FIG. 5 is a block diagram showing a control configuration of the liquid ejection apparatus 50. Through a host interface 502, image data is inputted from a host apparatus 501. This image data is stored in a reception buffer 506A provided in RAM 506. An image processing unit 504 converts the image data to multi-level data representing CMYK color components and stores the multi-level data in a multi-level data buffer 506B provided in the RAM 506. A print data processing unit 505 converts the multi-level data into dot data (binary data) and stores the dot data in a dot data buffer 506C. A liquid ejection head control unit 510 transfers the binary data stored in the dot data buffer 506C to the liquid ejection head 1. Processing performed by the print data processing unit 505 is in synchronization with a heat trigger signal 513 (see FIG. 6) outputted from a timing generation unit 509. Also, processing performed by the liquid ejection head control unit 510 is in synchronization with a block trigger signal 514 outputted from the timing generation unit 509. As will be described later, both of the heat trigger signal 513 and the block trigger signal 514 are in synchronization with encoder signals 511, 512 having positional information in the direction in which the liquid ejection head 1 is scanned (the main scanning direction). Thus, processing performed by the print data processing unit 505 and processing performed by the liquid ejection head control unit 510 are timed to the scanning of the liquid ejection head 1.

Note that reference numeral 503 in FIG. 5 denotes an operation panel used by a user to issue instructions to the liquid ejection apparatus 50. According to a control program stored in ROM 508, a processor 507 performs, e.g., control of driving of the print elements and control of conveyance of a printing medium (e.g., paper) relative to the print elements.

FIG. 6 is used to describe data transfer timing generation. In the driving method described here, print data for one column is divided into 16 timings (timedivision driving). The encoder signal (A-phase) 511 and the encoder signal (B-phase) 512 whose phase is shifted from the encoder signal (A-phase) 511 by a quarter of a cycle are inputted to the timing generation unit 509 from an encoder for generating encoder signals having positional information along the direction in which the liquid ejection head 1 is scanned. The timing generation unit 509 generates a reference pulse 601 at the rising edge of the encoder signal 511 and multiplies it, thereby generating and outputting the heat trigger signal 513 having an interval corresponding to the print resolution. Further, the timing generation unit 509 generates the block trigger signal 514 by dividing the interval of the heat trigger signal 513 by 16. Data is supplied to the liquid ejection head 1 at the timing of this block trigger signal 514. In this way, an image or the like can be printed at a desired position along the main scanning direction by transfer of data within a period corresponding to the cycle of the block trigger signal 514 generated based on the encoder signals 511, 512 having positional information on the liquid ejection head 1.

### Liquid Ejection Head Control Unit

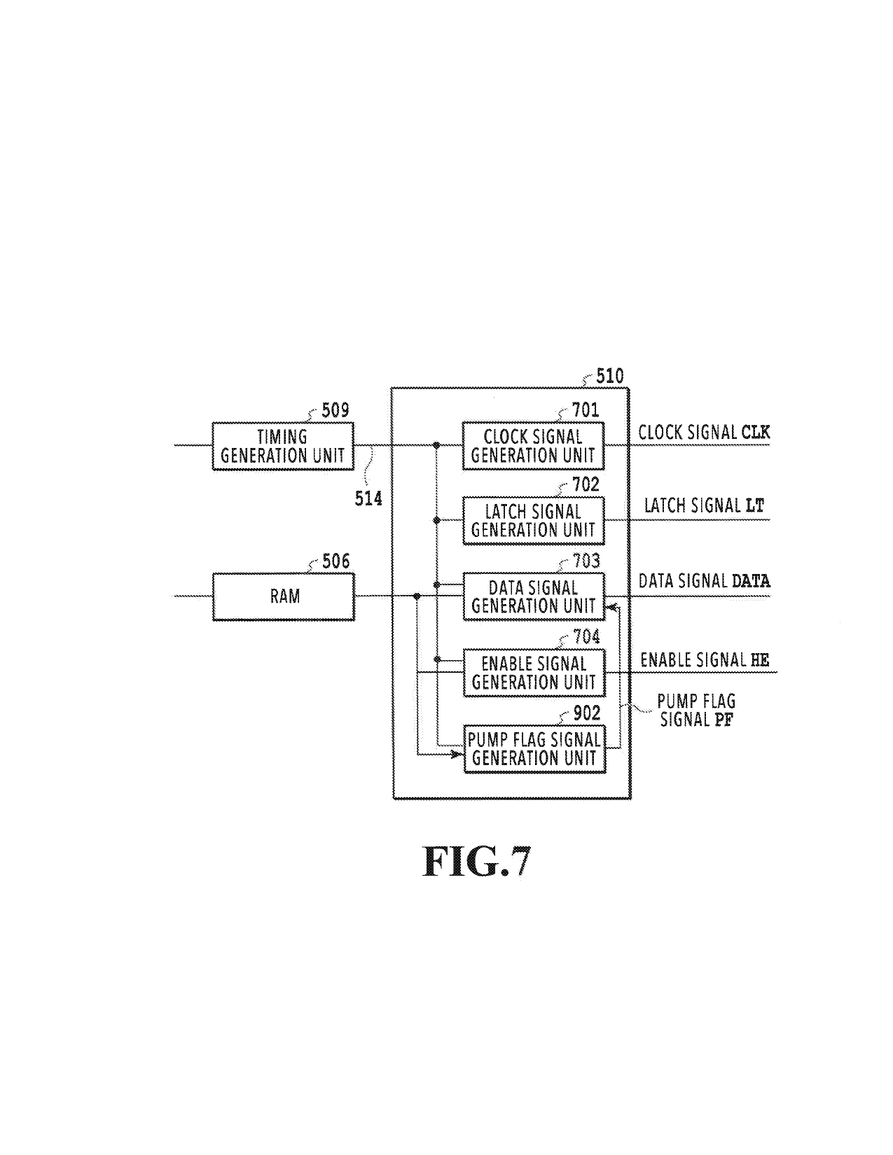

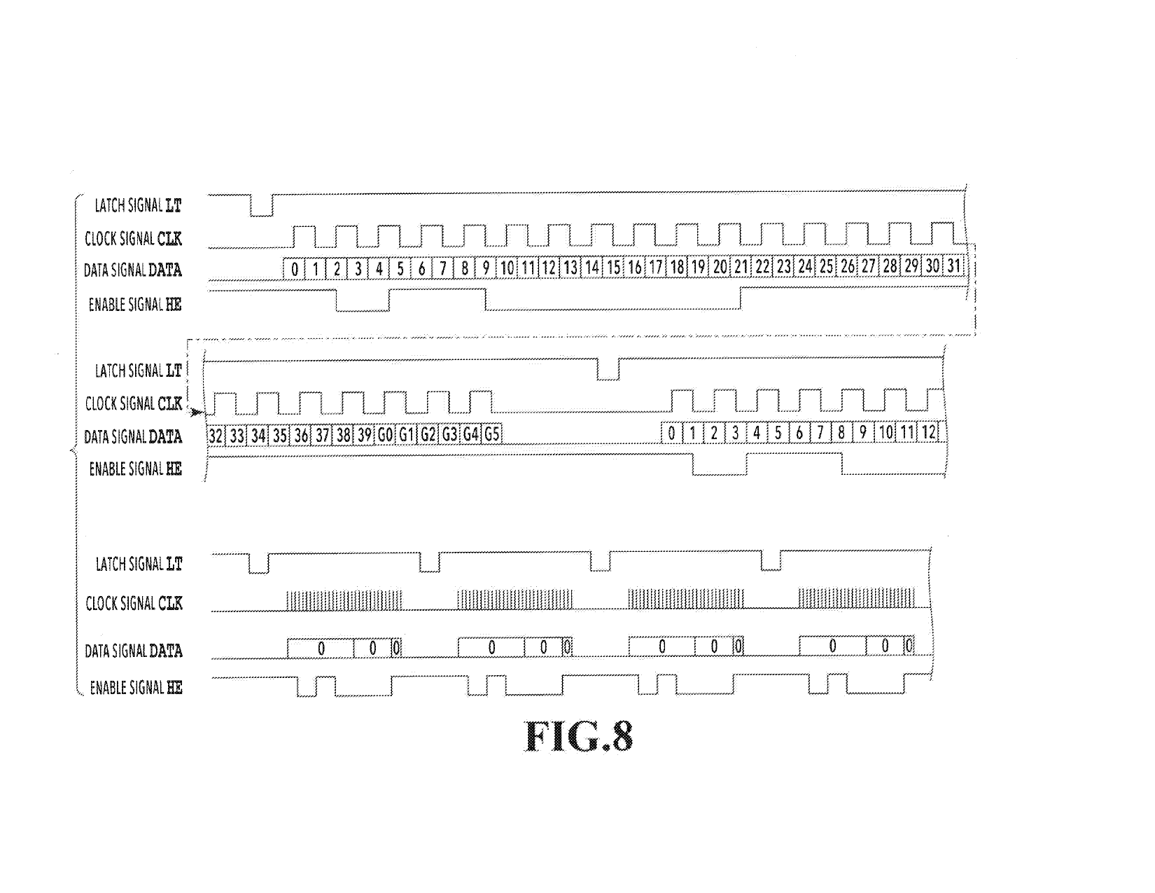

FIGS. 7 and 8 are used to describe the liquid ejection head control unit 510.

FIG. 7 is a block diagram showing the configuration of the liquid ejection head control unit 510. The liquid ejection head control unit 510 operates based on the timing of the block trigger signal 514 generated by the timing generation unit 509.

Upon input of the block trigger signal 514 from the timing generation unit 509, a clock signal generation unit 701 generates a clock signal for a predetermined number of cycles and transfers the clock signal to the liquid ejection head 1. In the example in FIG. 8, the clock signal generation unit 701 generates a clock signal for 23 cycles within every period of a latch signal. The number of cycles of a clock signal generated can be set variably, and a necessary number of cycles is determined depending on the bit size of data transferred to the liquid ejection head 1. For example, a clock signal is used to transmit serial data from the liquid ejection head control unit 510 to the print element substrate 201 using a data signal.

A latch signal generation unit 702, upon receipt of input of the block trigger signal 514, generates a latch signal LT and transfers the latch signal LT to the print element substrate 201 included in the liquid ejection head 1. For example, using the latch signal LT, serial data transmitted from the liquid ejection head control unit 510 to the print element substrate 201 is parallelized and latched on the print element substrate 201.

An enable signal generation unit 704 generates an enable signal EN based on data read by a data signal generation unit 703 from the RAM 506 and transfers the enable signal EN to the liquid ejection head 1. The enable signal EN is used to specify the length of time to drive the selected energy generation element in one period of the latch signal LT.

A pump flag signal generation unit 902 generates a pump flag signal. Details of the pump flag signal will be described later.

The data signal generation unit 703 generates a data signal including a group selection signal for ejection and a time-division selection signal for ejection. Upon receipt of input of the block trigger signal 514, the data signal generation unit 703 reads data such as image data from the RAM 506. Then, the data signal generation unit 703 temporarily stores, in an internal buffer, group selection signals for ejection and time-division selection signals for ejection for a single round of time division driving based on the data read. At the timing of the next input of the block trigger signal 514, the data signal generation unit 703 transfers the data signal to the print element substrate 201 included in the liquid ejection chip 301 of the liquid ejection head 1. Note that for every block trigger signal 514, data for a single round of time-division driving is transmitted from the liquid ejection head control unit 510 to the print element substrate 201 using a data signal.

Note that the data signal generation unit 703 also receives input of a pump flag signal. Then, at the timing of driving a circulation heater (thermoelectric conversion element) RhB, the group selection signal for ejection includes information for selecting the circulation heater (thermoelectric conversion element) RhB to be driven.

FIG. 8 shows a data signal including a 40-bit group selection signal for ejection (0 to 39) and a 6-bit time-division selection signal for ejection (G0 to G5). Among a plurality of ejection drive elements MD1 included in the liquid ejection head 1, ejection drive elements MD1 to be actuated are determined based on the group selection signals for ejection and the time-division selection signals for ejection transferred from the liquid ejection head control unit 510. The ejection drive elements MD1 thus determined drive the corresponding ejection energy generation elements 214 in a period of time in which the enable signal shows an enable level, thereby ejecting ink. The group selection signal for ejection and the time-division selection signal for ejection form ejection data. In the present embodiment, circulation data for driving a circulation drive element MD2 can be embedded in the ejection data, but a detailed description of this is omitted herein.

To actuate a particular ejection drive element MD1 is to cause the particular ejection drive element MD1 to drive the ejection energy generation element 214 corresponding thereto. Similarly, to actuate a particular circulation drive element MD2 is to cause the particular circulation drive element MD2 to drive the circulation energy generation element 224 corresponding thereto.

FIG. 8 shows an example where the time-division selection signal for ejection is formed by six bits (G0 to G5). This makes it possible to support a configuration where a single block has 64 ejection energy generation elements 214 at maximum. However, in the present embodiment where a single block has only 16 ejection energy generation elements 214, the time-division selection signal for ejection only needs to be formed by four bits (G0 to G3).

The time-division selectin signal for ejection changes so that for every latch signal, the ejection drive element MD1 and the circulation drive element MD2 to be actuated in the group may be selected on a rotation basis. In a case where a group has N ejection drive elements MD1 and N circulation drive elements MD2, a single rotation is made with every N latch signals. In a case where, for example, an adjustment is made so that the time-division selection signal repeats enabling and disabling the circulation drive element MD2 alternately with every N latches, the period in which the time-division selection signal makes a single rotation of the N circulation drive elements MD2 can be doubled.

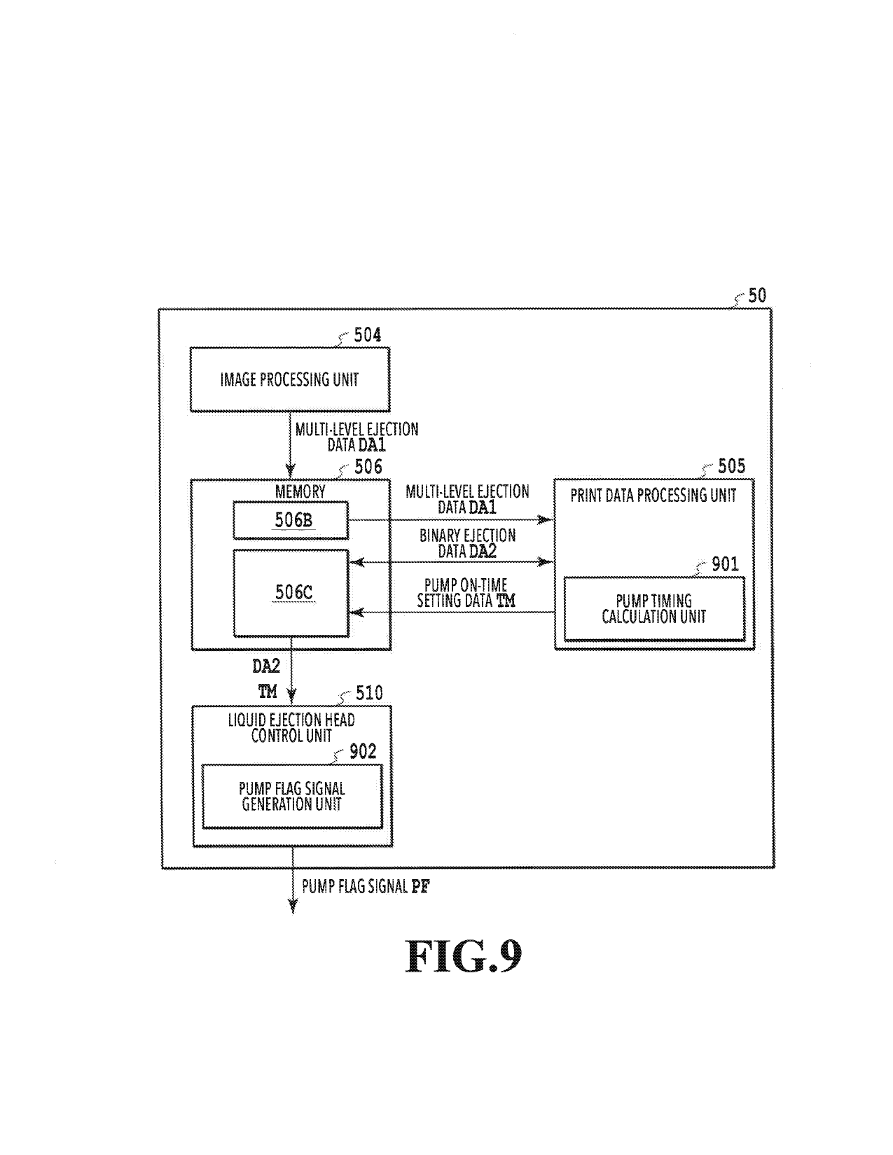

FIG. 9 is a functional block diagram of part of the liquid ejection apparatus according to the first embodiment.

In the first embodiment, as shown in FIG. 9, the print data processing unit 505 has a pump timing calculation unit 901, and the liquid ejection head control unit 510 has the pump flag signal generation unit 902. In the first embodiment, in an inter scan period between a scan period for printing and the next scan period, the pump timing calculation unit 901 calculates the timing to drive the circulation energy generation elements in the next scan period. The pump flag signal generation unit 902 operates in real time in the scan period.

Multi-level ejection data DA1 generated by the image processing unit 504 is stored in the multi-level data buffer 506B temporarily and then supplied to the print data processing unit 505.

The print data processing unit 505 generates binary ejection data DA2 based on the multi-level ejection data DA1. The binary ejection data DA2 is stored in the dot data buffer 506C.

Based on the binary ejection data DA2, the pump timing calculation unit 901 included in the print data processing unit 505 generates pump on-time setting data TM having information related to the timing at which a pump flag is changed from low to high. The pump on-time setting data TM is stored in the dot data buffer 506C as well.

In the inter-scan period, the binary ejection data DA2 and the pump on-time setting data TM stored in the dot data buffer 506C are supplied to the liquid ejection head control unit 510 in the next scan period.

The pump flag signal generation unit 902 included in the liquid ejection head control unit 510 generates a pump flag signal based on the pump on-time setting data TM. The pump flag signal is supplied to the print element substrate 201 included in the liquid ejection chip 301. Note that the pump flag signal may be supplied directly to the print element substrate 201 or may be included in data signal DATA by the data signal generation unit 703 as described earlier.

The pump timing calculation unit 901 may be inside the liquid ejection head control unit 510. In this case, the pump timing calculation unit 901 generates the pump on-time setting data TM based on the binary ejection data DA2.

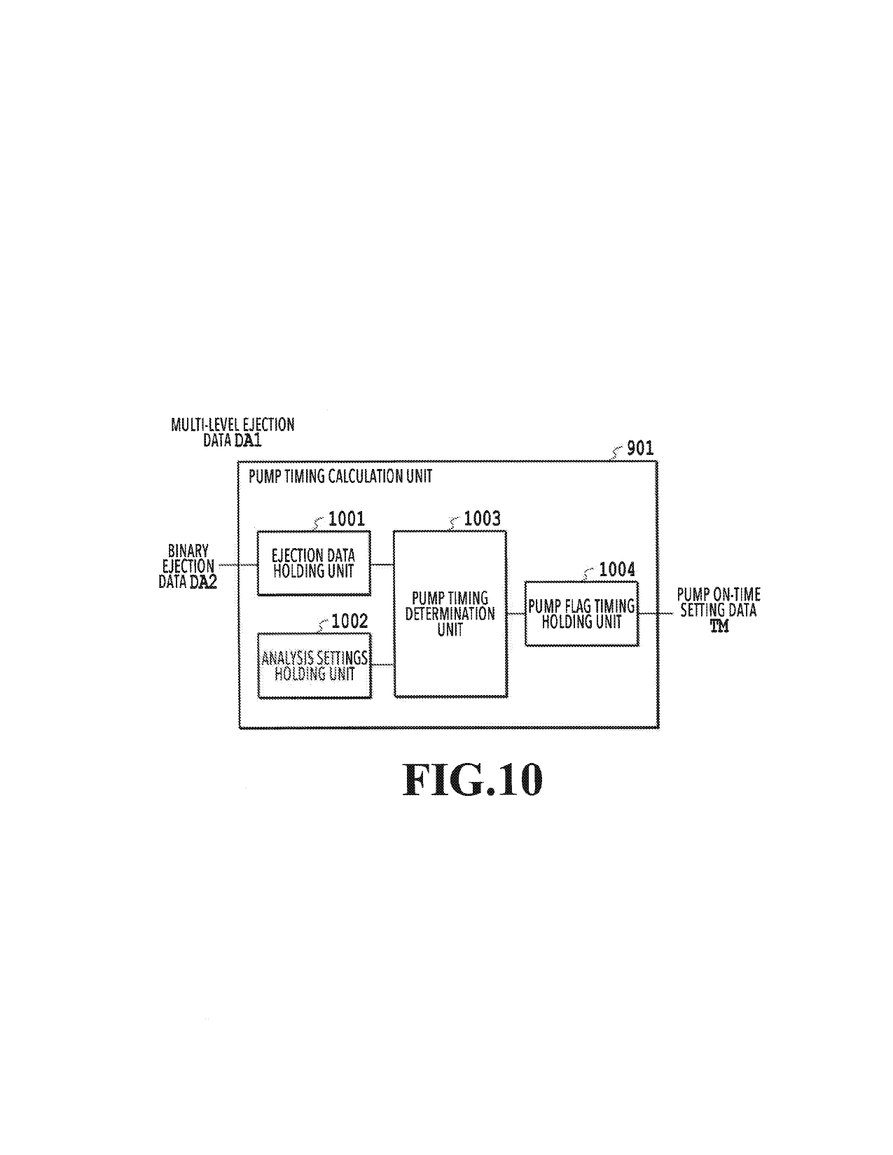

FIG. 10 is a functional block diagram of the pump timing calculation unit 901 according to the first embodiment.

Referring to FIG. 10, an ejection data holding unit 1001 holds the multi-level ejection data DA1 received from the multi-level data buffer 506B.

An analysis settings holding circuit 1002 holds the following:

the number n of analysis columns used for a single determination

an analysis grouping setting

a column number k for driving the circulation energy generation elements 224

the number of columns per scan.

Based on the binary ejection data DA2 received from the ejection data holding unit 1001 and the information held in the analysis settings holding circuit 1002, a pump timing determination unit 1003 calculates the timing at which the circulation drive element MD2 drives the circulation energy generation element 224. Then, the pump timing determination unit 1003 saves the pump on-time setting data TM having that timing information to a pump flag timing holding unit 1004. Then, the pump on-time setting data TM is read from the pump flag timing holding unit 1004 and transferred to the dot data buffer 506C. These operations are performed in the inter-scan period.

The pump on-time setting data TM includes a column number for driving the circulation energy generation elements 224. The pump flag signal generation unit 902 can hold information related to two column numbers. One of the column numbers is used for signal generation by the pump flag signal generation unit 902 and is then updated to the next column number.

For instance, clm1, clm2, and clm3 (clm1 < clm2 < clm3) are the column numbers for driving the circulation energy generation elements 224. In this instance, the dot data buffer 506C holds the column numbers clm1 and clm2 first. Then, after the pump flag signal generation unit 902 generates a pump flag signal based on clm1, the dot data buffer 506C updates the column numbers to hold to clm2 and clm3. Note that the number of column numbers held by the pump flag signal generation unit 902 is not limited to 2 and may be other numbers.

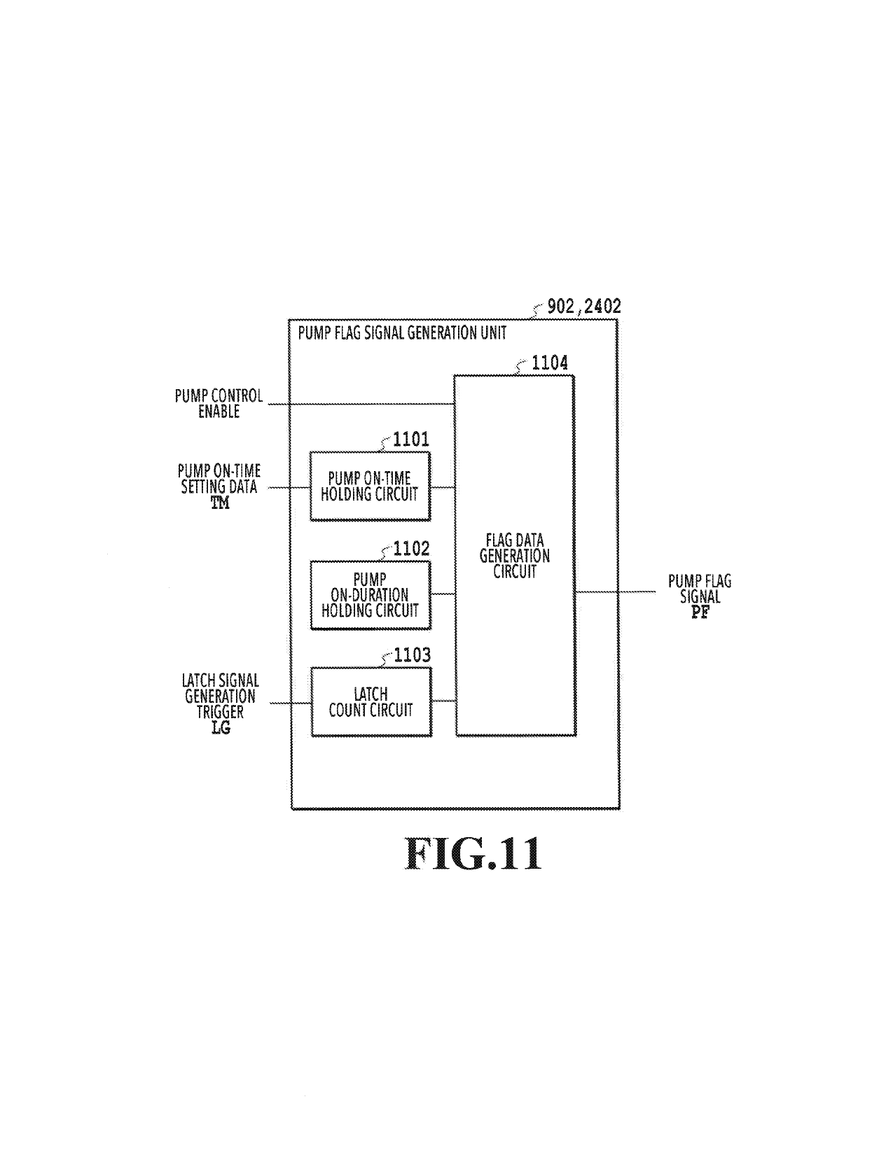

FIG. 11 is a functional block diagram of the pump flag signal generation unit 902 according to the first embodiment.

The pump flag signal generation unit 902 includes a pump on-time holding circuit 1101 configured to hold the pump on-time setting data TM received from the dot data buffer 506C and a pump on-duration holding circuit 1102 configured to hold a duration TN in which a pump flag stays high. A pump flag goes high at a time specified by the pump on-time setting data TM and then stays high for a period specified by the duration TN. Then, the circulation energy generation elements 224 are driven by the circulation drive elements MD2 in the period in which the pump flag is high. In other words, the circulation pump is driven in the period in which the pump flag is high.

A flag data generation circuit 1104 receives input of the pump on-time setting data TM, the pump on-duration held in the pump on-duration holding circuit 1102, a count value inputted from a latch count circuit 1103, and a pump control enable. Then, the flag data generation circuit 1104 generates a pump flag signal PF based on these sets of input data. Specifically, the flag data generation circuit 1104 sets the pump flag signal to high once the count value matches the pump on-time setting data TM. Then, the flag data generation circuit 1104 keeps the pump flag signal high for the number indicated by the pump on-duration. The flag data generation circuit 1104 performs such an operation only in a case where the pump control enable indicates "enable" and keeps the pump flag signal low at all times in a case where the pump control enable indicates "disable."

### Pump Flag Timing Calculation Method

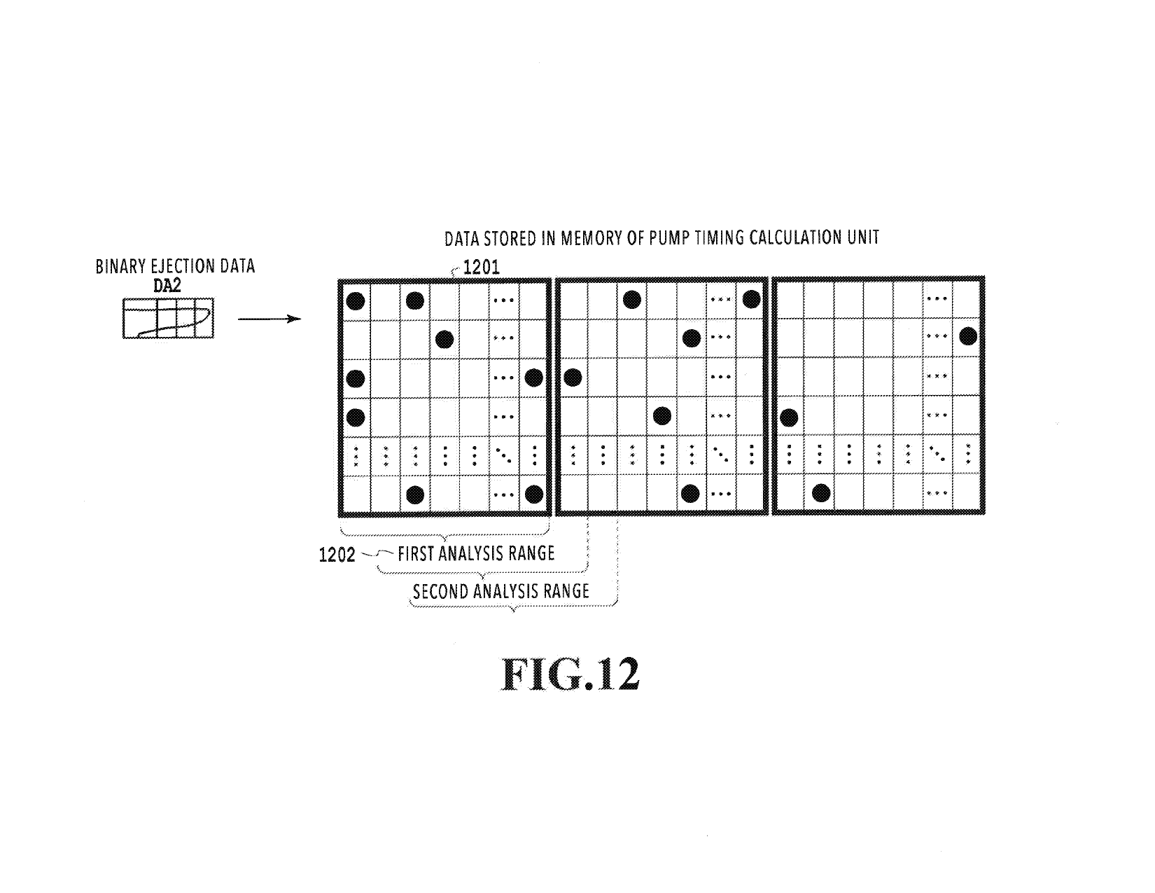

FIG. 12 is a diagram showing data stored in memory according to the first embodiment.

In FIG. 12, each horizontal array represents a nozzle and each vertical array represents a column. A block with a black dot indicates that the corresponding nozzle performs ejection in the corresponding column. What is meant by "performing ejection" is that the ejection energy generation element 214 is driven by the ejection drive element MD1.

For instance, the block which is the fourth one from the left and the second one from the top has a black dot, and this means that the second nozzle from the top performs ejection in the fourth column (i.e., there is ejection data).

The pump timing calculation unit 901 receives the binary ejection data DA2. The binary ejection data DA2 is held in the ejection data holding unit 1001. In a case where the binary ejection data DA2 being held is short of data necessary for analysis, the shortage is complemented. The case where the binary ejection data DA2 being held is short of data necessary for analysis is a case where, while the binary ejection data DA2 needs to have data for (n + 1) columns starting from a column m, which is the inspection start position, to a column (m + n), which is the inspection end position, some of them are lacking. The complement is performed on a macro block basis as shown with a thick-line frame 1201, the macro block being formed of a plurality of nozzles and a plurality of columns.

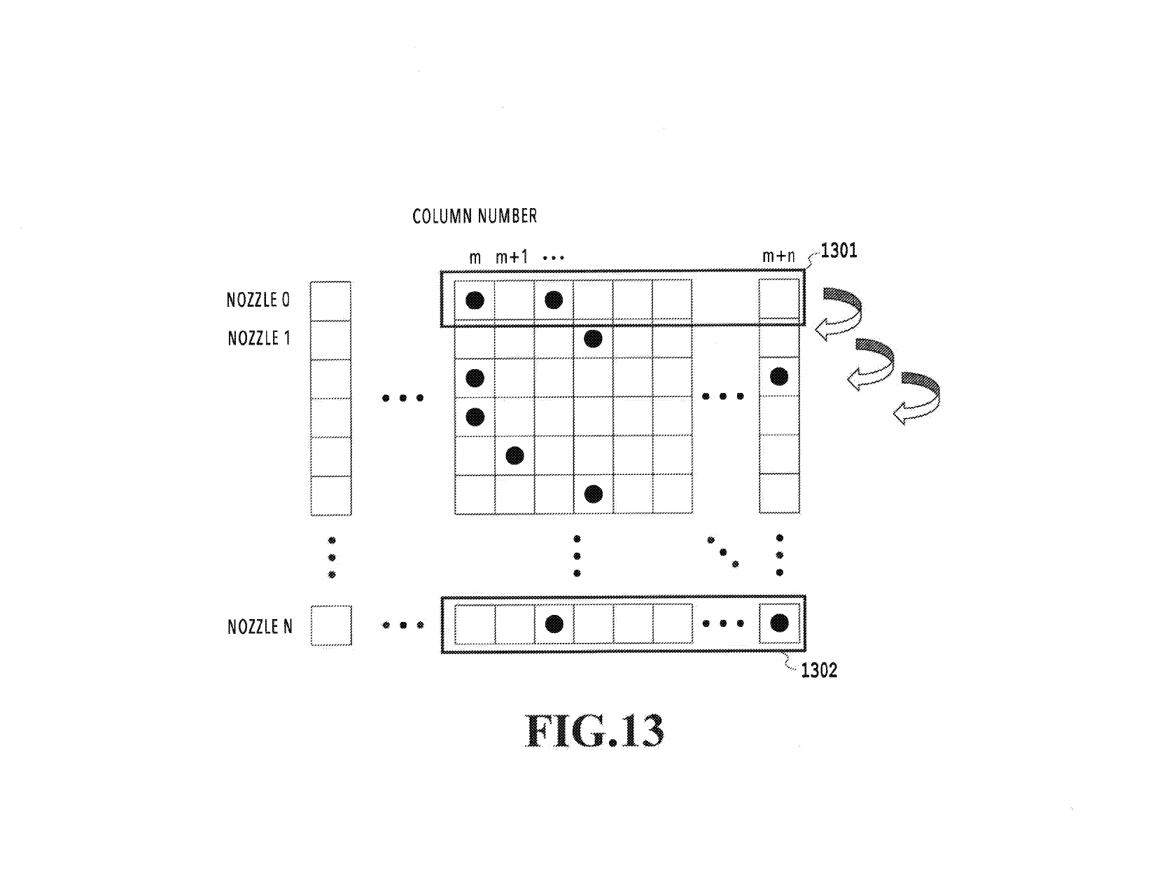

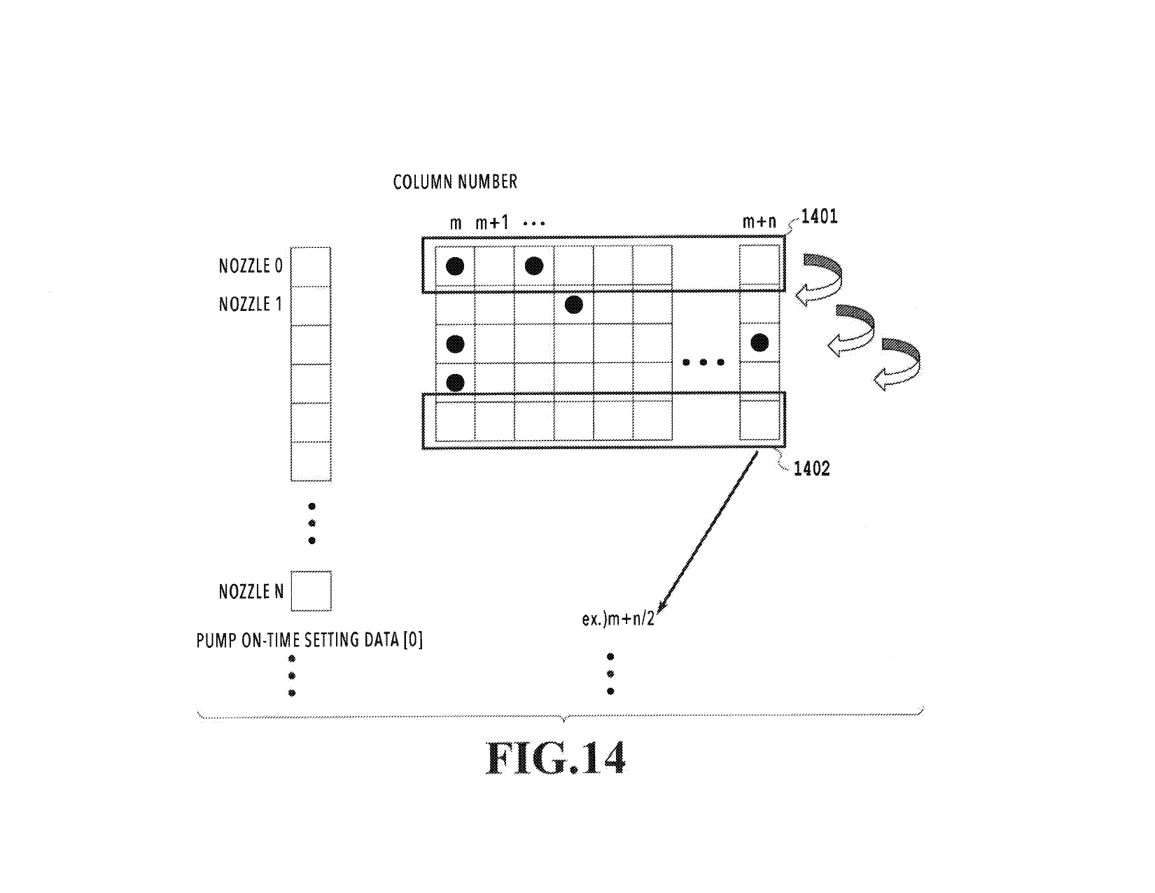

FIGS. 13 and 14 are diagrams each illustrating a pump timing calculation method by the pump timing determination unit 1003 included in the pump timing calculation unit 901. In this calculation method, nozzles O to N are checked, and the columns m to (m + n) are checked. Thus, (N + 1) × (n + 1) blocks are an inspection range. Note that the columns m to (m + n) are an inspection zone.

The method shown in FIG. 13 and the method shown in FIG. 14 are the same, but the procedure after the checking is different depending on whether there is ejection data.

FIG. 13 shows a method where all the nozzles (the nozzles 0 to N) perform ejection at least once. In this case, the circulation pumps are not driven.

FIG. 14 shows a case where at least one nozzle has no ejection data within a set number of columns. In this example, the set number of columns is (n + 1). In this case, the circulation pumps are driven.

Here, basically, (N + 1) circulation pumps corresponding to the nozzles 0 to N are driven. However, an adjustment may be made so as not to drive circulation pumps corresponding to, among the (N + 1) ejection energy generation elements 214 corresponding to the nozzles Oto N, the ejection energy generation elements 214 that are driven.

The pump timing determination unit 1003 first determines whether there is ejection data for the first nozzle (the nozzle 0) within the column range (the columns m to (m + n)). The pump timing determination unit 1003 repeats this for the second nozzle (the nozzle 1) to the last nozzle (the nozzle N).

However, as will be described later, in a case where it is determined that a nozzle in the middle has no ejection data, determinations may be omitted for the subsequent nozzles.

In the example in FIG. 13, all the nozzles (the nozzles 0 to N) have ejection data, the determination of whether there is ejection data is performed for all the nozzles.

In the example in FIG. 14, a nozzle in the middle has no ejection data, and thus, the determination of whether there is ejection data is not performed for the nozzles after the nozzle in the middle.

Also, in the example in FIG. 14, the circulation pumps at positions corresponding to a range m to a range (m + n) are turned on. The circulation pump turned on here only needs to be a circulation pump corresponding to the nozzle without ejection data. Thus, a procedure or a circuit may be added to not tum on circulation pumps corresponding to the nozzles with ejection data. This procedure or circuit performs processing to make a correction such that B' = not(A)·B, where A is a signal for actuating the ejection drive element, and B is a signal for actuating the circulation drive element.

In a case where all the nozzles has ejection data in at least one column as shown in FIG. 13, the inspection range is shifted by one in a column direction (i.e., the scan direction). Then, the same operation is performed for the newly set column range (from the column (m + 1) to the column (m + n + 1)).

In a case where there is a certain nozzle without ejection data within the range of the columns m to (m + n) as shown in FIG. 14, a column number according to a setting (e.g., (m + n)/2 (rounded up)) is recorded. The column number is transferred to the pump flag timing holding unit 1004. Thus, circulation pumps are driven in one or more columns corresponding to the column number (m + n)/2.

As an example, the column number is set to (m + n)/2 because if, for example, m + n were set as a column number, a circulation pump would be less effective in a case where there is ejection data immediately after the circulation pump is driven. However, the setting value is not limited to (m + n)/2. Setting the column number to (m + n)/2 allows a non-drive zone where neither the ejection energy generation element 214 nor the circulation energy generation element 224 is driven to be provided after the column where the circulation energy generation element 224 is driven. Also, similarly, setting the column number to (m + n)/2 allows a non-drive zone where neither the ejection energy generation element 214 nor the circulation energy generation element 224 is driven to be provided before the column where the circulation energy generation element 224 is driven.

In a case where circulation pumps are driven, the column number is advanced by (m + n)/2, and the above-described operation is repeated.

Note that the above-described column number is not limited to (m + n)/2 (rounded up), but may be, for example, (m + n)/2 (rounded down), m + a × n (0 < a < n) (rounded up), or m + a × n (0 < a < n) (rounded down).

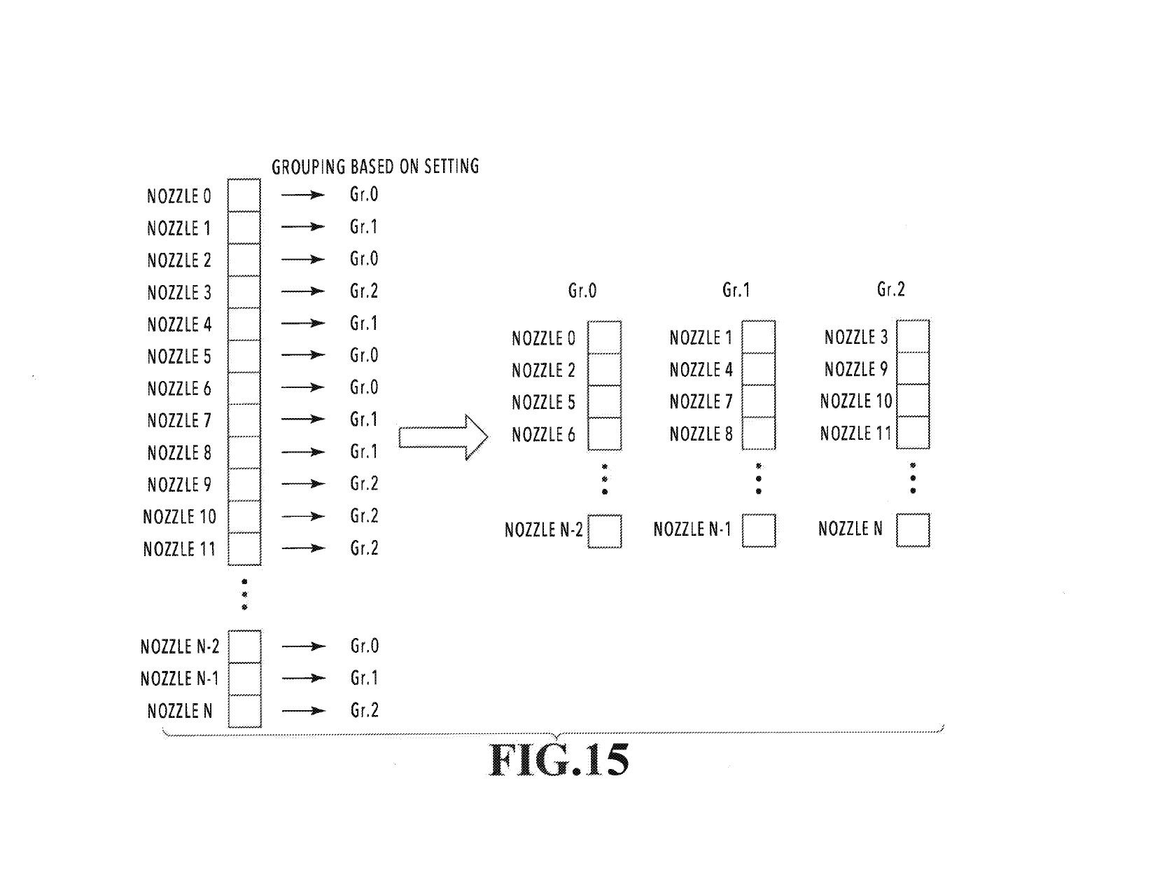

Although there are (N + 1) nozzles in FIGS. 13 and 14, instead of using all the nozzles of the head, the nozzles may be grouped and narrowed down to check a limited number of nozzles, as shown in FIG. 15. For example, in a case where the total number of nozzles is 160, the nozzles are equally divided into, for example, ten groups each including 16 nozzles. Then, the above-described method is employed on each of the groups. Specifically, the method is repeated ten times with N = 16.

### Pump Flag Timing Calculation Flowchart

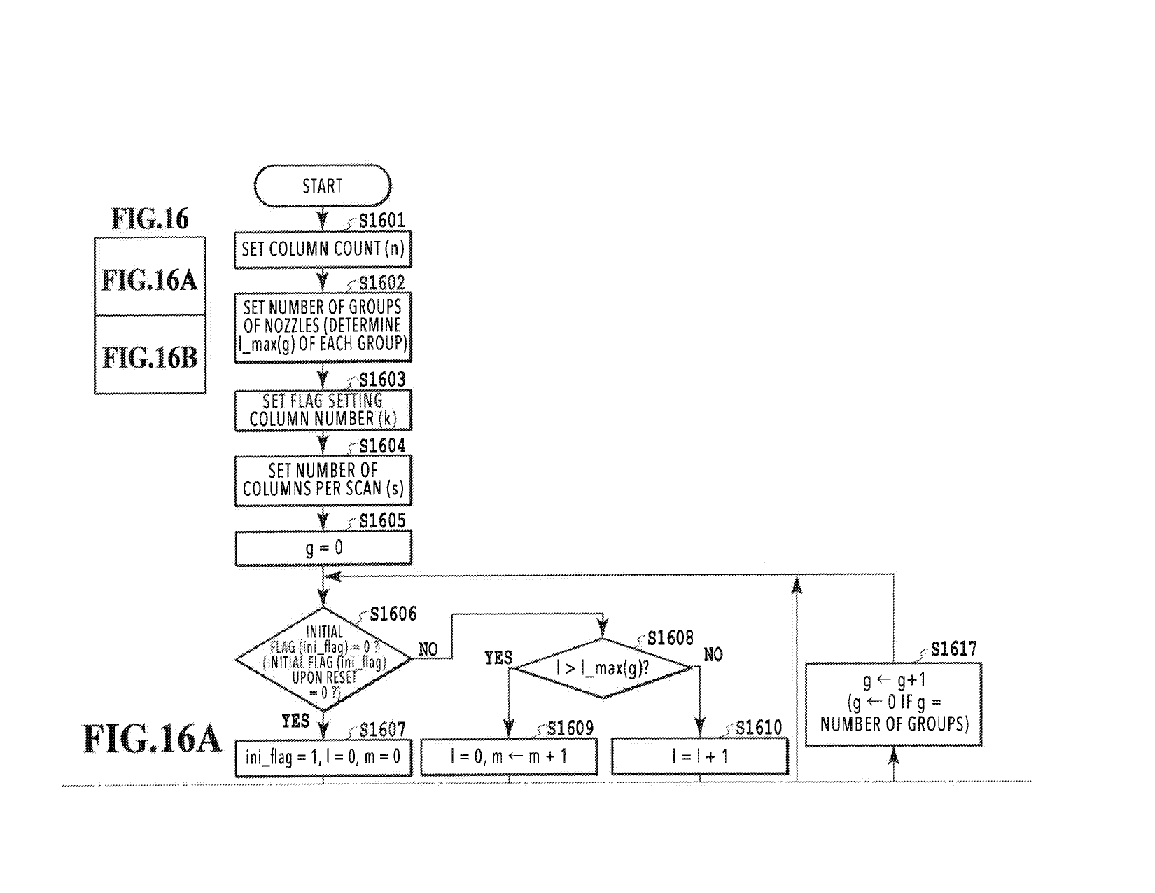

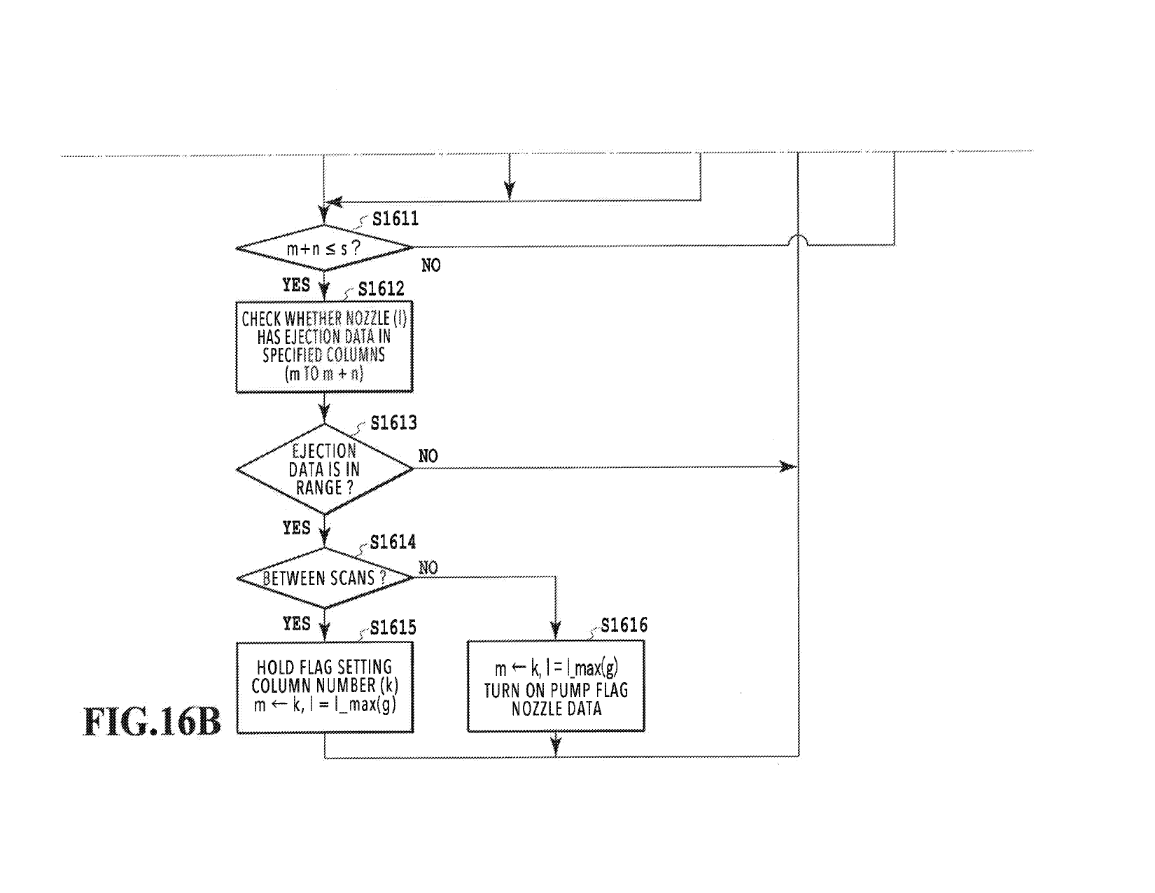

FIGS. 16A and 16B are a flowchart showing an operation performed by the pump timing calculation unit 901.

First, necessary numerical values are set.

In S1601, the pump timing calculation unit 901 sets a target column count n for a single inspection. This is stored in the analysis settings holding circuit 1002. The pump timing determination unit 1003 receives the target column count n and uses it for processing.

In S1602, the pump timing calculation unit 901 configures a setting for dividing all the nozzles into groups. The number of nozzles in each group is 1_max(g) (where g is a group number).

In S1603, the pump timing calculation unit 901 sets a column k in which circulation pumps are driven if it is determined that there is no ejection data as a result of checking whether there is ejection data for the columns m to (m + n) in each of the groups. The column number k is, for example, k = n/2 (rounded up).

In S1604, the pump timing calculation unit 901 sets the number of columns per scans.

In S1605, 0 is plugged into g.

Also a flag called an initial flag is defined. The initial flag is 0 (active) upon reset.

In S1606, the pump timing calculation unit 901 checks this initial flag (ini_flag). If the initial flag is active (YES), in S1607, the pump timing calculation unit 901 initializes a nozzle number 1 checked for ejection data and a column number m checked for ejection data to 0, and sets the initial flag to 1 (inactive).

If the initial flag is inactive (NO) in S1606, in S1608 the pump timing calculation unit 901 checks whether the nozzle number 1checked for ejection data exceeds the maximum nozzle count 1_max(g).

If the nozzle number 1 exceeds the maximum nozzle count 1_max(g) in S1608 (YES), in S1609 the pump timing calculation unit 901 initializes the nozzle number 1 to O and check the next column (m = m + 1). As a result of the calculation m = m + 1, the inspection zone is shifted by one column. As a result, the start position of the next inspection shifts by one column from the start position of the current inspection.

If the nozzle number 1 does not exceed the maximum nozzle count 1_max(g) in S1608 (NO), in S1610 the pump timing calculation unit 901 increments the nozzle number 1 by 1 (1 = 1 + 1).

In S1611, the pump timing calculation unit 901 checks whether the range (m + n) to check for ejection data is the number of columns per scan s or below.

If m + n >sin S1611, in S1617 the pump timing calculation unit 901 checks the next nozzle group (g = g + 1). In this event, the initial flag is set to 0 (active).

If m + n ≤ s in S1611, in S1612 the pump timing calculation unit 901 checks for ejection data within the specified range (the nozzle 1 in the columns m to (m + n)). Then in S1613, the pump timing calculation unit 901 determines whether there is ejection data within the range.

If it is determined in S1613 that there is ejection data within the range, the pump timing calculation unit 901 repeats the operation from S1606.

If it is determined in S1613 that there is no ejection data within the range, in S1614 the pump timing calculation unit 901 determines whether calculation timing is between scans. If calculation timing is between scans (YES), the processing proceeds to S1615, and if calculation timing is not between scans (NO), the processing proceeds to S1616.

In S1615, the column number k is held in the pump flag timing holding unit 1004. Also, m is updated to k, and 1_max(g) is plugged into 1. Updating m to k (executing computation of m = k) shifts the inspection zone by k columns. As a result, the start position of the next inspection shifts by k columns from the start position of the current inspection.

In S1616, pump flag nozzle data (to be described later) is turned on. Also, m is updated to k, and 1_max(g) is plugged into 1.

Note that in S1615 or S1616, if the number of columns win which to drive circulation pumps are known, m may be updated not to k, but to any value within the range from k to (k + w).

After that, the operation is repeated again from S1606.

### Pump Flag Timing Calculation Timing Chart

A description is given using FIG. 11.

As shown in FIG. 11, the pump flag signal generation circuit 902 generates the pump flag signal PF.

The pump flag signal PF rises once the counter in the latch count circuit 1103 which operates in conjunction with a latch signal generation trigger LG reaches a value indicated by the pump on-time setting data TM. After that, after the counter increases by the value held in the pump on-duration holding circuit 1102, the pump flag signal PF falls.

The flag data generation circuit 1104 functions only in a case where the pump control enable is active.

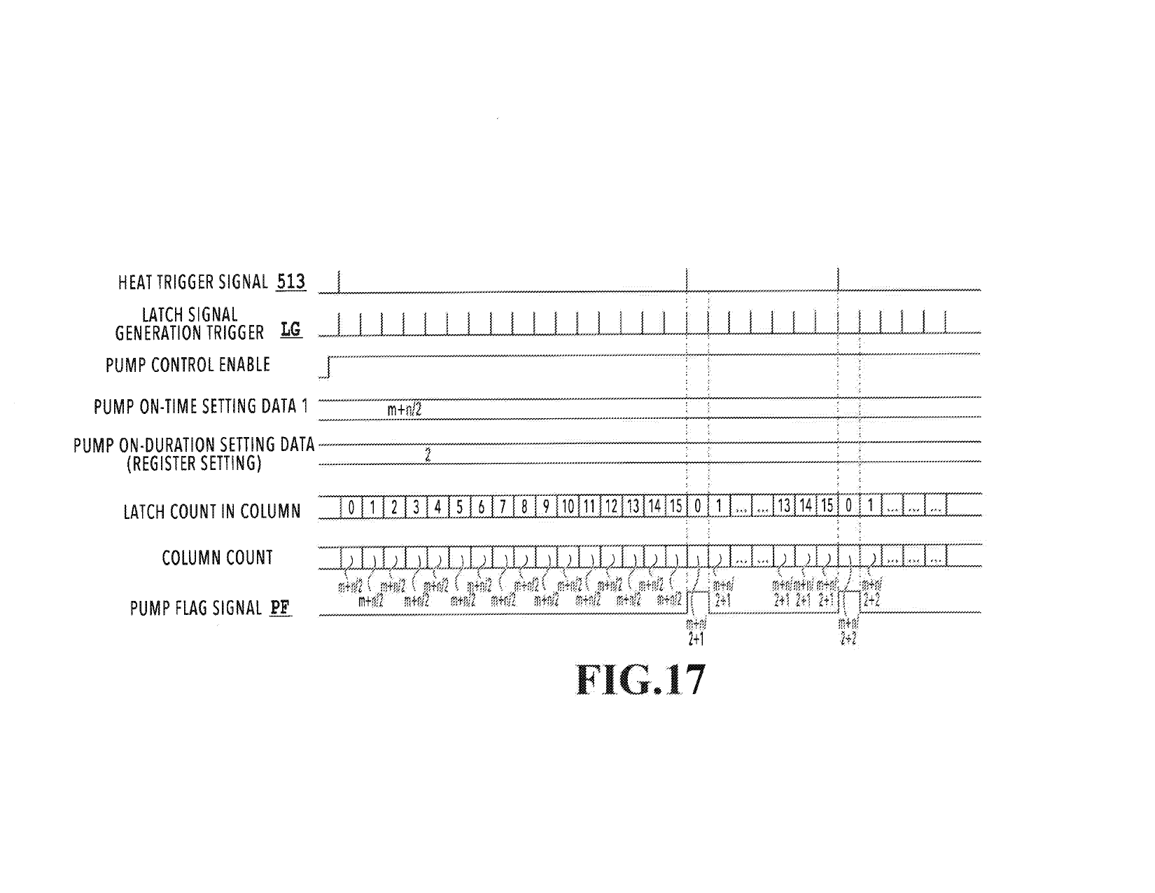

FIG. 17 is a timing chart showing the timing at which the pump flag is set in the first embodiment. As shown in FIG. 17, as an example, pump on-time setting data_1 is (m + n)/2, and pump on-duration setting data is 2. Thus, the pump flag signal PF goes high in the following two latch periods:

(a) a latch period in which a column count is (m + n)/2 and a latch count in the column is zero, and

(b) a latch period in which the column count is (m + n)/2 + 1 and a latch count in the column is zero.

In response to the pump flag signal that goes high in the period (a) described above, 16 circulation pumps in the group are turned on one by one in 16 latch periods where the latch count in a column increases from 0 to 15 in the column period with a column count of (m + n)/2. Also, in response to the pump flag signal that goes high in the period (b) described above, 16 circulation pumps in the group are turned on one by one in 16 latch periods where the latch count in a column increases from 0 to 15 in the column period with a column count of (m + n)/2 + 1. This control for the circulation pumps can be performed on each of the groups simultaneously and independently among the groups.

Note that in a case where the pump on-duration setting data is, for example, 2, the same circulation pump can be driven twice, which makes it possible to help overcome a situation where one-time driving is not enough to achieve sufficient ink circulation.

The configuration of the first embodiment makes it possible to freely set the timing to drive the circulation pumps based on ejection data and therefore to drive the circulation pumps so as not to lower circularity.

Also, because the pump on-duration is settable, the period of time of one-time driving of a circulation pump can be set freely as well. This enables the circulation pumps to be driven so as not to lower circularity.

### Second Embodiment

### Control Configuration

The control configuration is the same between the second embodiment and the first embodiment.

### Data Transfer Timing Generation

The data transfer timing generation is the same between the second embodiment and the first embodiment.

### Liquid Ejection Head Control Unit

The liquid ejection head control unit is the same between the second embodiment and the first embodiment.

### Block Configuration

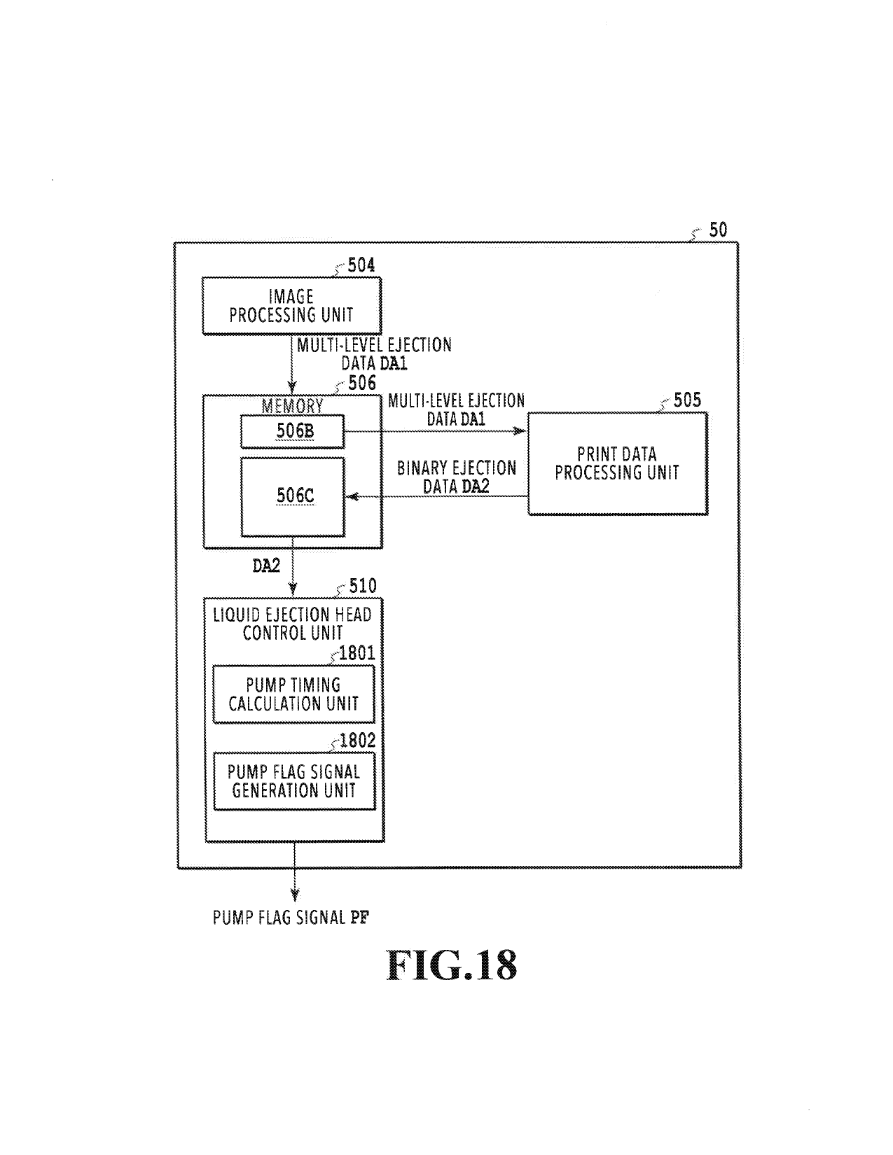

The second embodiment has the configuration shown in FIG. 18 instead of the configuration of the first embodiment shown in FIG. 9.

While the pump timing calculation unit 901 is included in the print data processing unit 505 in the first embodiment, a pump timing calculation unit 1801 is included in the liquid ejection head control unit 5101 in the second embodiment. In the first embodiment, the pump flag signal generation unit 902 operates in a scan period based on the pump on-time setting data TM generated by the pump timing calculation unit 901 in an inter-scan period. By contrast, in the second embodiment, the pump timing calculation unit 1801 operates in real time in a scan period as a pump flag signal generation unit 1802 does.

The multi-level ejection data DA1 outputted from the image processing unit 504 is stored in the multi-level data buffer 506B. The binary ejection data DA2 generated by the print data processing unit 505 based on the multi-level ejection data DA1 is stored in the dot data buffer 506C.

The binary ejection data DA2 is read from the dot data buffer 506C and supplied to the liquid ejection head control unit 510. In the present embodiment, the binary ejection data DA2 is supplied to the pump timing calculation unit 1801 to be specific.

The pump flag signal generation unit 1802 receives input of pump flag nozzle data PN having pump flag timing information from the pump timing calculation unit 1801 and generates the pump flag signal PF based on the pump flag nozzle data PN.

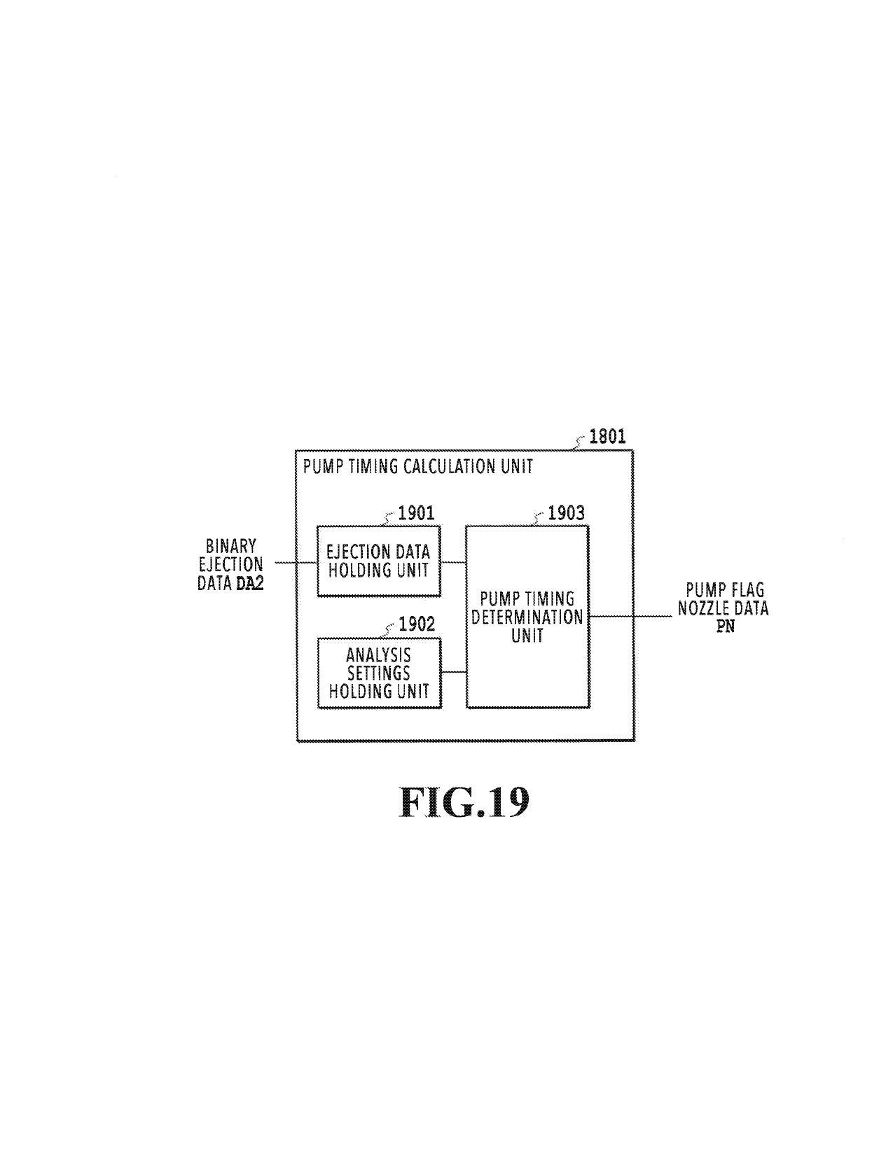

FIG. 19 is a functional block diagram of the pump timing calculation unit 1801 of the second embodiment.

An ejection data holding unit 1901 holds the binary ejection data DA2 received from the dot data buffer 506C.

An analysis settings holding circuit 1902 holds the number of analysis columns used for a single determination, a setting on analysis grouping, a setting on the column number for driving the pumps based on analysis, and a setting on the number of columns per scan.

A pump timing determination unit 1903 receives and obtains input of the binary ejection data DA2 from the ejection data holding unit 1901 and analysis setting information from the analysis settings holding circuit 1902. Then, the pump timing determination unit 1903 calculates timing to turn on the circulation pumps based on these pieces of data and information inputted thereto and supplies the pump flag signal generation unit 1802 with the pump flag nozzle data PN having information related to the timing calculated.

In the first embodiment, data supplied from the pump timing calculation unit 901 to the pump flag signal generation unit 902 is the pump on-time setting data TM. By contrast, in the second embodiment, data supplied from the pump timing calculation unit 1801 to the pump flag signal generation unit 1802 is the pump flag nozzle data PN. Thus, in the second embodiment, the pump timing calculation unit 1801 and the pump flag signal generation unit 1802 can operate in real time in a scan period.

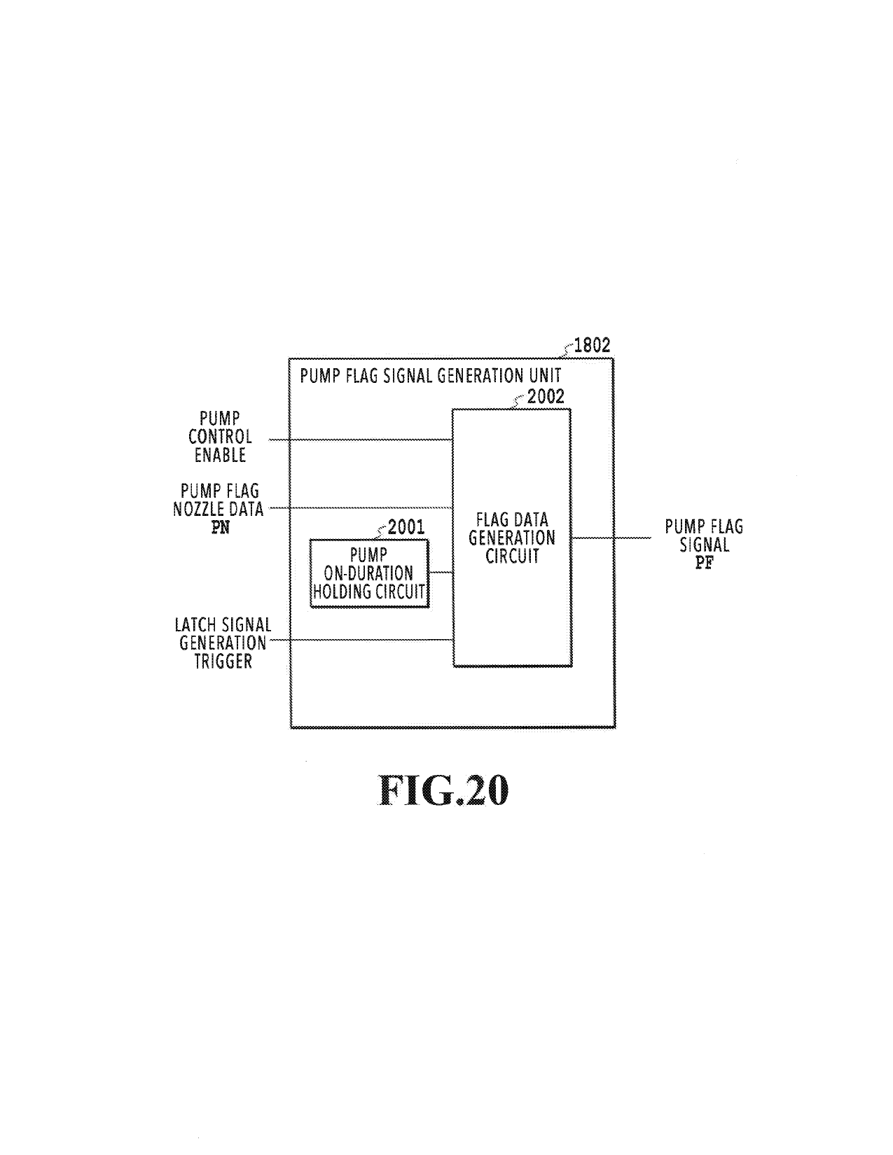

FIG. 20 is a functional block diagram of the pump flag signal generation unit 1802 according to the second embodiment.

The pump flag signal generation unit 1802 includes a pump on-duration holding circuit 2001 configured to hold a setting on a duration of time from turning on the circulation pumps to turning off the circulation pumps.

The pump flag signal generation unit 1802 operates in conjunction with the latch signal generation trigger LG supplied from the timing generation unit 509.

A flag data generation unit 2002 is supplied with a pump control enable signal, the pump flag nozzle data PN, data indicating a pump on-duration, and the latch signal generation trigger LG. The flag data generation unit 2002 generates the pump flag signal PF based on these signals and data.

### Pump Flag Timing Calculation Method

The pump flag timing calculation method according to the second embodiment is as shown in FIG. 16 and is the same as that in the first embodiment.

Note that in the first embodiment, the determination result of S1614 is YES, and then S1615 is executed, but in the second embodiment, the determination result of S1614 is NO, and then S1616 is executed.

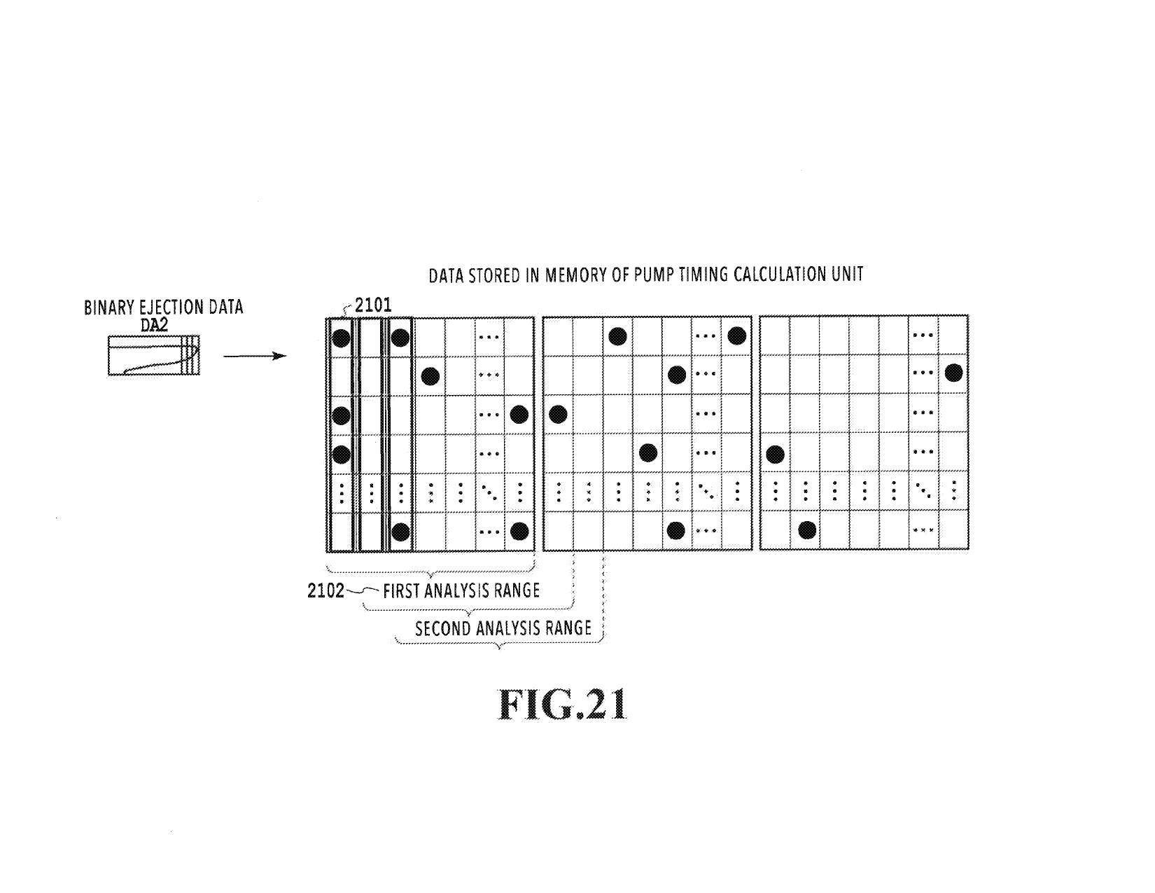

FIG. 21 is a diagram showing data stored in memory in the second embodiment.

In FIG. 21, like in FIG. 12, each horizontal array represents a nozzle, and each vertical array represents a column. A block with a black dot indicates that the corresponding nozzle performs ejection in the corresponding column.

The pump timing calculation unit 1801 receives the binary ejection data DA2 from the dot data buffer 506C. In this event, in a case where the binary ejection data DA2 is short of data necessary for analysis of a data range and corresponding to data in the set number of columns held in the analysis settings holding circuit 1902, the liquid ejection head control unit 510 additionally receives the binary ejection data DA2 from the dot data buffer 506C.

The case where the binary ejection data DA2 is short of data corresponding to data in the set number of columns held in the analysis settings holding circuit 1902 is a case where, for example, in a case of analyzing data from the m-th column to the (m + n)-th column, the binary ejection data DA2 covering this range is not received from the dot data buffer 506C.

A single unit of reception in this event is indicated by a black frame 2101.

The pump timing determination unit 1903 employs the calculation method shown in FIG. 13 like in the first embodiment.

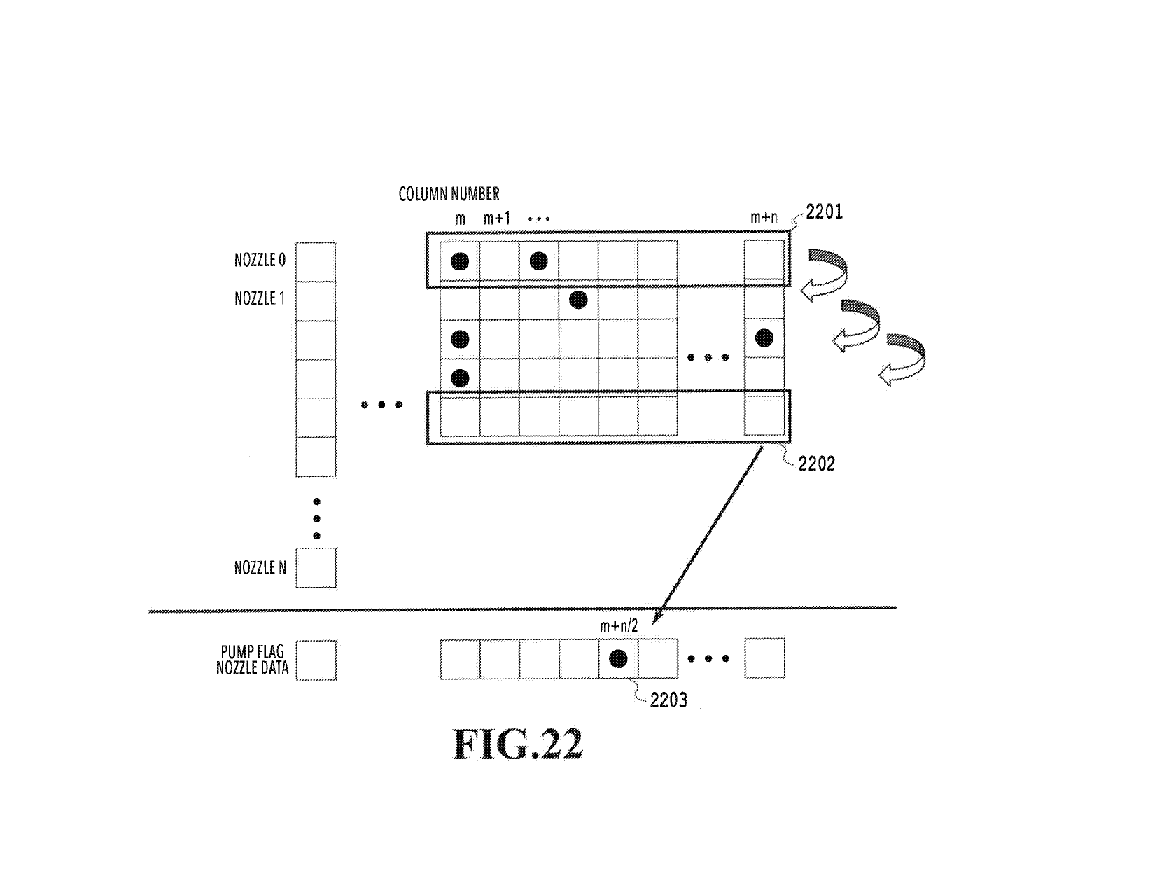

FIGS. 13 and 22 both show an ejection data checking procedure. The difference between FIGS. 13 and 22 is whether ejection data is present or absent.

FIG. 13 is the same as the first embodiment.

Next, FIG. 22 is referred to for description.

As shown in FIG. 22, a certain nozzle is checked for ejection in a set column range 2202 held in the analysis settings holding circuit 1902. Once a nozzle without ejection data in any of them-th to (m + n)-th columns (i.e., a nozzle that does not eject in any of those columns) is found, pump flag nozzle data PN which goes active at timing 2203 (e.g., (m + n)/2 (rounded up) in FIG. 22) is generated.

The pump flag nozzle data PN is transferred to the pump flag signal generation unit 1802.

No checking is performed for the subsequent nozzles, and a similar procedure is performed starting from the column ((m + n)/2 (rounded up) + 1) after the above-described column number ((m + n)/2 (rounded up)).

In the first embodiment, in the pump flag signal generation unit 902 shown in FIG. 11, the pump flag signal PF goes high in the column where its latch count equals the pump on-time setting data TM. In the second embodiment, by contrast, the pump flag nozzle data PN itself shows the timing at which the pump flag signal PF goes high. The pump flag signal PF which has gone high stays high for a period corresponding to the number of columns set in the pump on-duration holding circuit 2001.

The nozzles may be grouped in the second embodiment like in the first embodiment.

### Pump Flag Timing Calculation Timing Chart

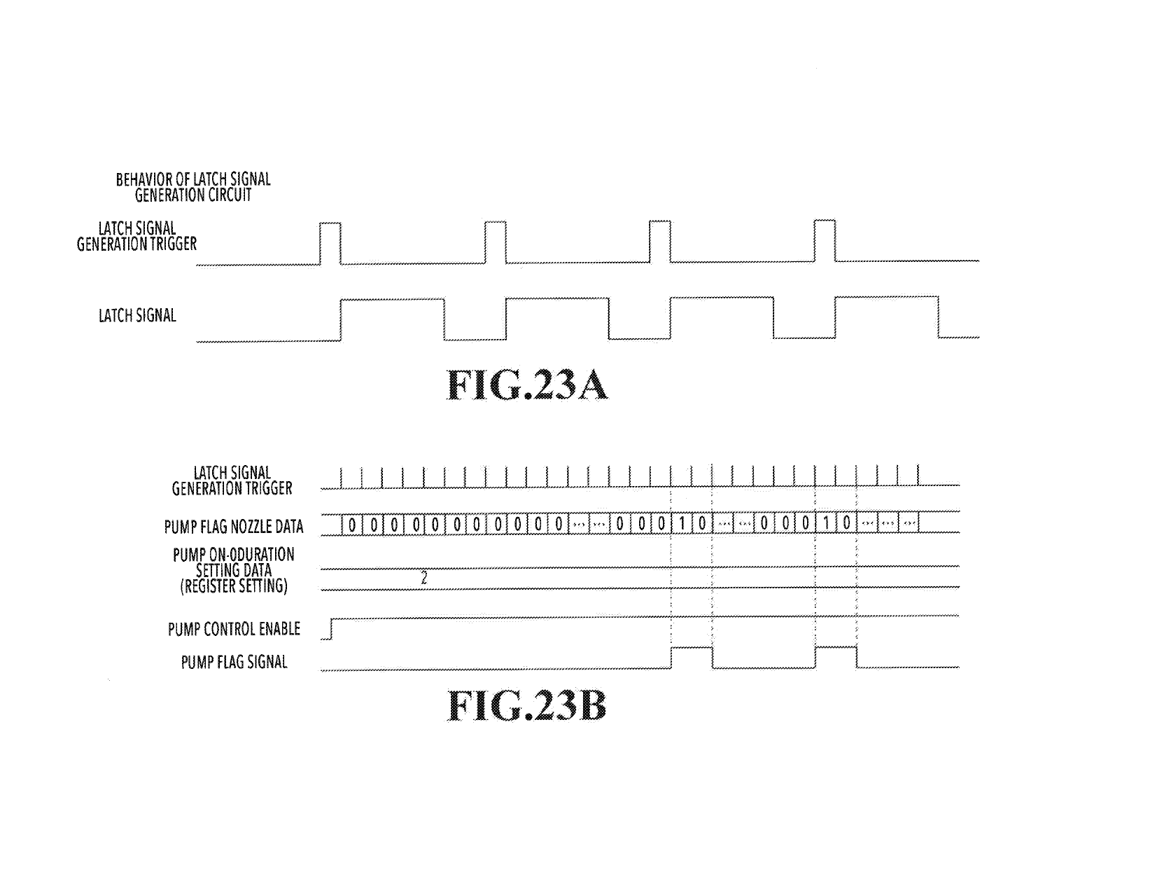

FIGS. 23A and 23B show timing charts of pump flag timing calculation according to the second embodiment.

As shown in FIGS. 23A and 23B, the pump flag data generation unit 2002 included in the pump flag signal generation unit 1802 generates the pump flag signal PF.

As shown in FIGS. 23A and 23B, the pump flag signal PF goes high in the column where the pump flag nozzle data PN turns 1. Then, the pump flag signal PF stays high for as long as the pump on-duration (2 in the example in FIG. 23B) held in the pump on-duration holding circuit 2001.

Note that the flag data generation unit 2002 functions only in a case where the pump control enable is active.

The second embodiment, like the first embodiment, can set timing to drive the circulation pumps freely based on ejection data. Also, the second embodiment, like the first embodiment, can set the period of time for driving the circulation pumps as well. Thus, the second embodiment, like the first embodiment, can drive the circulation pumps so as not to lower liquid circularity.

Also, according to the second embodiment, the pump timing calculation unit 1801 is in the liquid ejection head control unit 510. This makes it possible to calculate timing to control the circulation pumps based on post-image-processing data existing in the liquid ejection head control unit 510. Thus, ejection data used to find the timing to control the circulation pumps becomes closer to the ejection data for driving the ejection energy generation elements 214 in the print element substrate 201. Thus, the accuracy of timing to drive the circulation pumps can be improved.

### Third Embodiment

### Control Configuration

The control configuration is the same between the third embodiment and the first embodiment.

### Data Transfer Timing Generation

The data transfer timing generation is the same between the third embodiment and the first embodiment.

### Liquid Ejection Head Control Unit

The liquid ejection head control unit is the same between the third embodiment and the first embodiment.

### Block Configuration

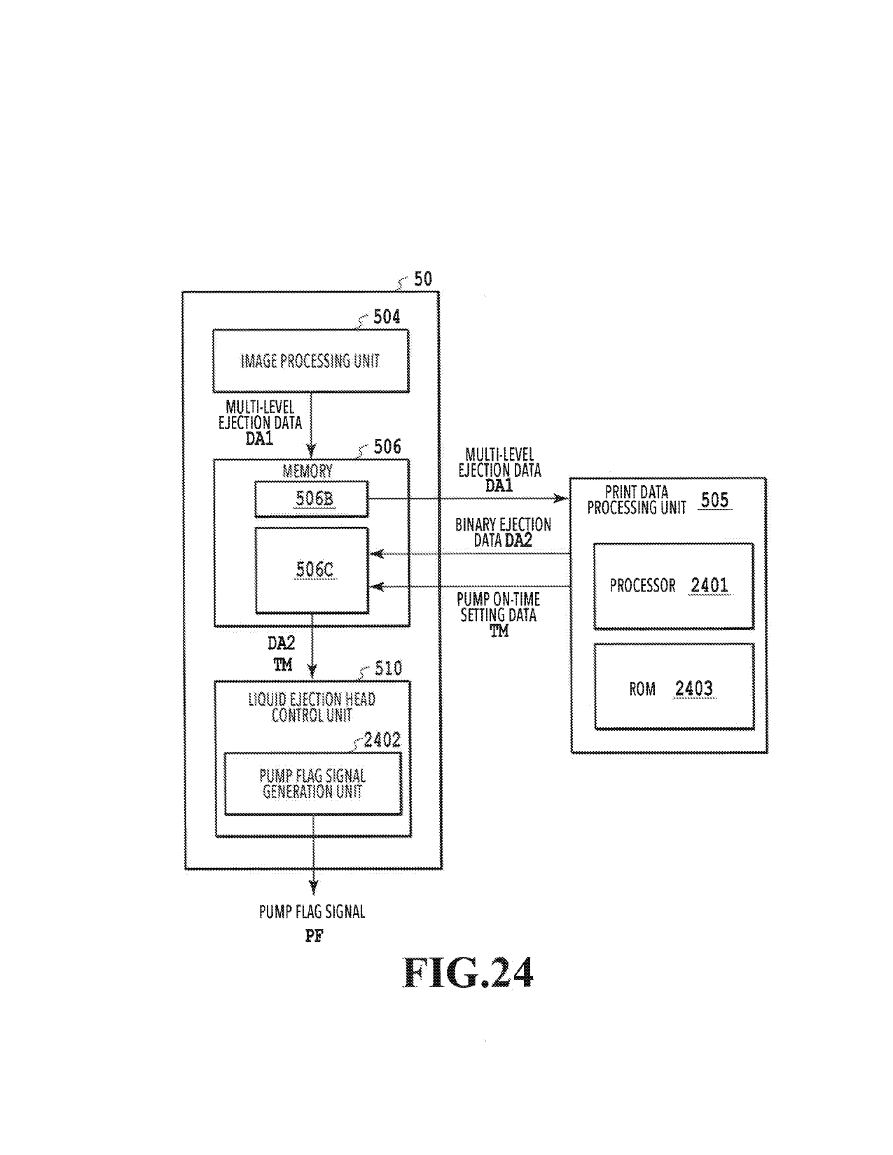

The third embodiment has the configuration shown in FIG. 24 instead of the configuration of the first embodiment shown in FIG. 9. In the third embodiment, the print data processing unit 505 and the pump timing calculation unit 901 included in the print data processing unit 505 in the first embodiment are replaced by a processor 2401 configured to execute programs stored in ROM 1103. In the third embodiment, like in the first embodiment, the pump flag signal generation unit 902 operates in a scan period based on the pump on-time setting data TM generated in an inter-scan period by the processor 2401 functioning as the pump timing calculation unit 901. The pump timing calculation unit 901 embodied by the processor 2401 that operates according to a program is the same as that of the first embodiment and is therefore not described here to avoid repetition.

A pump flag signal generation unit 2402 according to the third embodiment is the same as the pump flag signal generation unit 902 of the first embodiment and is therefore not described here to avoid repetition.

### Pump Flag Timing Calculation Method

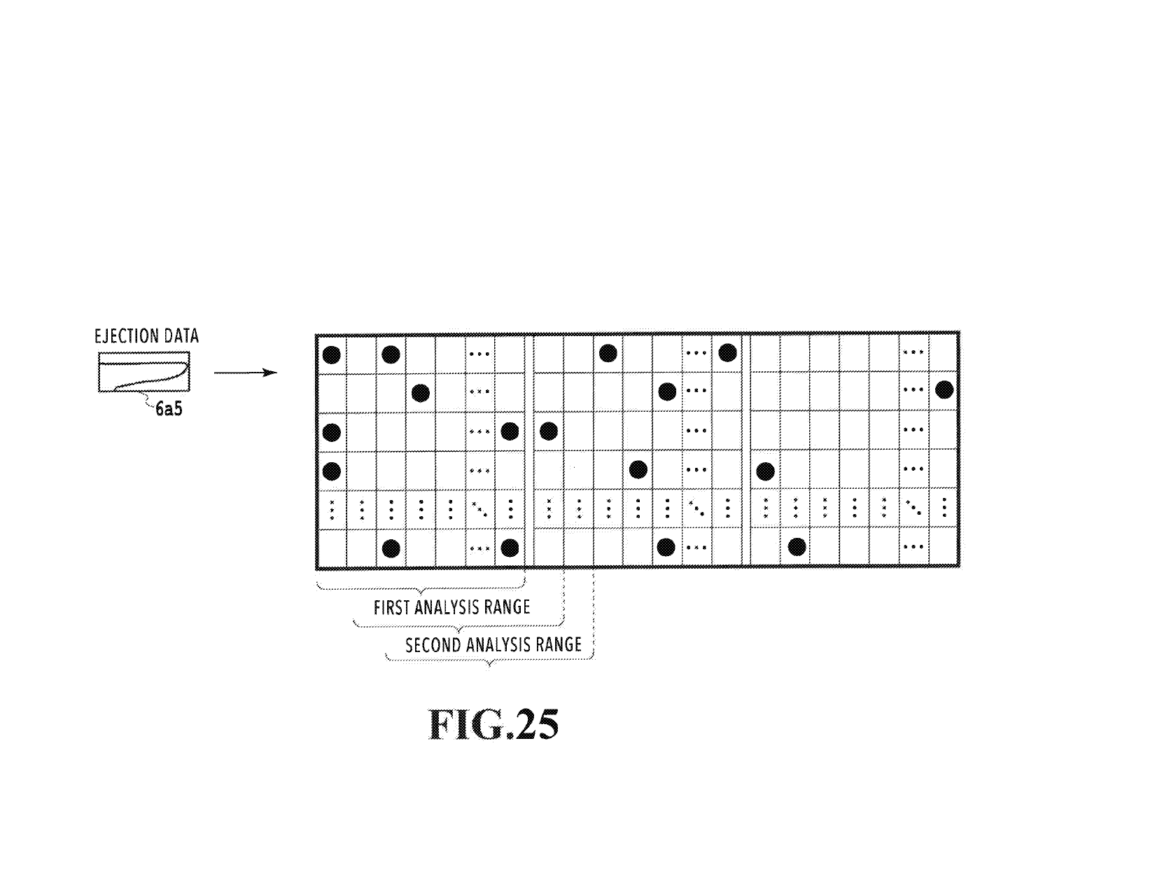

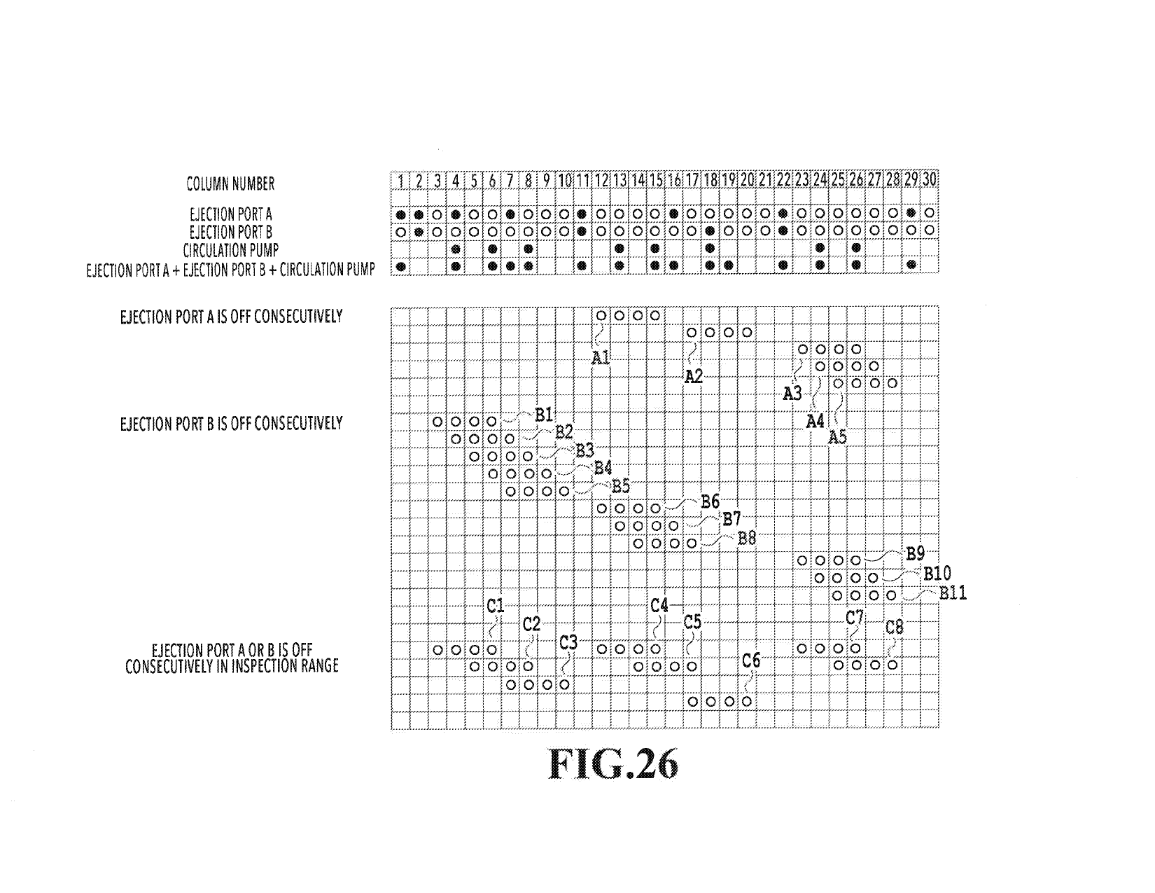

In the first embodiment, the ejection data holding unit 1001 fetches ejection data in a unit indicated by the thick frame in FIG. 12. By contrast, in the third embodiment, the processor 2401 fetches ejection data in a unit indicated by the thick frame in FIG. 25. Other points are the same as the first embodiment and are not described here to avoid repetition.

### Pump Flag Timing Calculation Flowchart

The pump flag timing calculation flowchart is the same as the first embodiment.

### Pump Flag Timing Calculation Timing Chart

The pump flag timing calculation timing chart is the same as the first embodiment.

The third embodiment can offer advantageous effects similar to those offered by the first embodiment. Also, according to the third embodiment where the processor 2401 performs processing, the pump timing calculation unit 901 formed by hardware can be eliminated.

### Example

FIG. 26 is a diagram illustrating an example. In the present example, one group includes two ejection ports (an ejection port A and an ejection port B).

From the ejection port A, ink is ejected at columns 1, 2, 4, 7, 11, 16, 22, and 29. From the ejection port B, ink is ejected at columns 2, 11, 18, and 22. Also, in the present example, "n" and "k" described in the embodiments are 4 and 2, respectively.

In this case, as shown in FIG. 26, the circulation pumps are turned on in the columns 4, 6, 8, 13, 15, 18, 24, and 26. This point is described below.

The ejection port A is turned off four columns in a row in five regions denoted by Al to AS. The ejection port B is turned off four columns in a row in eleven regions denoted by B1 to B11.

First, a region C1, which is the same as the region B1, is detected as a region where either the ejection port A or the ejection port B is turned off four columns ma row. In response to this, the circulation pumps are turned on in column 4.

Because the inspection zone advances by k = 2 columns, a region C2, which is the same as the region B3, is detected as a region where either the ejection port A or the ejection port B is turned off four columns in a row. In response to this, the circulation pumps are turned on in column 6.

Because the inspection zone advances by k = 2 columns, a region C3, which is the same as the region B5, is detected as a region where either the ejection port A or the ejection port B is turned off four columns in a row. In response to this, the circulation pumps are turned on in column 8.

Because the inspection zone advances by k = 2 columns and then advances one column at a time (k = 2 columns), a region C4, which is the same as the region Al, is detected as a region where either the ejection port A or the ejection port B is turned off four columns in a row. In response to this, the circulation pumps are turned on in column 13.

Because the inspection range advances by k = 2 columns, a region C5, which is the same as the region B8, is detected as a region where either the ejection port A or the ejection port B is turned off four columns in a row. In response to this, the circulation pumps are turned on in column 15.

Because the inspection zone advances by k = 2 columns and then advances one column at a time (k = 2 columns), a region C6, which is the same as the region A2, is detected as a region where either the ejection port A or the ejection port B is turned off four columns in a row. In response to this, the circulation pumps are turned on in column 18.

Because the inspection zone advances by k = 2 columns and then advances one column at a time (k = 2 columns), a region C7, which is the same as the region A3, is detected as a region where either the ejection port A or the ejection port B is turned off four columns in a row. In response to this, the circulation pumps are turned on in column 24.

Because the inspection zone advances by k = 2 columns, a region C8, which is the same as the region A5, is detected as a region where either the ejection port A or the ejection port B is turned off four columns in a row. In response to this, the circulation pumps are turned on in column 26.

Here, the circulation pumps are turned on in columns 4,6,8, 13, 15, 18, 24, and 26 as described earlier. However, in column 4, ejection from the ejection port A and turning on of the circulation pump corresponding to the ejection port A occur simultaneously and overlap. Thus, an adjustment is made so that the circulation pump corresponding to the ejection port A will not be turned on in column 4 to prioritize ejection from the ejection port A. For example, the print element substrate 201 includes a circuit for making this adjustment.

In column 18, ejection from the ejection port Band turning on of the circulation pump corresponding to the ejection port B overlap. Thus, an adjustment is made so that the circulation pump corresponding to the ejection port B will not be turned on in column 18 to prioritize ejection from the ejection port B. For example, the print element substrate 201 includes a circuit for making this adjustment.

### Other Embodiments

In the embodiments described above, in a case where at least one of nozzles belonging to a group performs ejection in any of the columns in an inspection range, in principle, all the circulation pumps belonging to the group are turned on. However, the present disclosure is not limited to this, and all the circulation pumps belonging to the group may be turned on in principle as long as there are N or more such ejection ports, where N is 2 or greater and the total number of ejection ports or smaller.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment( s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

The present disclosure can prevent liquid circularity from lowering while ejection energy generation elements are not driven.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176652, filed October 8, 2024, which is hereby incorporated by reference herein in its entirety.

What is claimed is:

1. A liquid ejection apparatus including
a liquid ejection head configured to eject liquid to a printing medium along a scanning direction and
a liquid ejection head control unit configured to control the liquid ejection head, wherein
the liquid ejection head comprises:
a plurality of ejection ports through which the liquid is ejected;
a plurality of pressure chambers communicating with the plurality of respective ejection ports;
a plurality of ejection energy generation elements each configured to generate energy for ejecting the liquid in a corresponding one of the plurality of pressure chambers through a corresponding one of the plurality of ejection ports;
a plurality of circulation energy generation elements each configured to generate energy for circulating the liquid in a corresponding one of the plurality of pressure chambers through a flow channel inside the liquid ejection head;
a plurality of ejection drive elements each configured to drive a corresponding one of the plurality of ejection energy generation elements based on ejection data; and
a plurality of circulation drive elements each configured to drive a corresponding one of the plurality of circulation energy generation elements based on circulation data, and
the liquid ejection head control unit comprises:
a unit configured to generate the ejection data based on image data; and
a generation unit configured to generate the circulation data based on the ejection data, the circulation data being such that in a case where a certain one of the ejection drive elements does not drive the ejection energy generation element corresponding to the certain one of the ejection drive elements within an inspection zone defined in the ejection data and shifted in the scanning direction, the circulation drive element corresponding to the certain one of the ejection drive elements drives the circulation energy generation element corresponding to the circulation drive element in a drive zone included in the inspection zone.

2. The liquid ejection apparatus according to claim 1, wherein
in a case where the certain one of the ejection drive elements drives the ejection energy generation element corresponding to the certain one of the ejection drive elements in the inspection zone, the generation unit generates the circulation data such that in the inspection zone, the circulation drive element corresponding to the certain one of the ejection drive elements does not drive the circulation energy generation element corresponding to the circulation drive element.

3. The liquid ejection apparatus according to claim 1, wherein
the plurality of ejection drive elements are divided into a plurality of groups, and
the plurality of circulation drive elements are divided into the plurality of groups.

4. The liquid ejection apparatus according to claim 3, wherein
in a case where at least one of the plurality of ejection drive elements belonging to a certain one of the groups does not drive at least one ejection energy generation element corresponding to the at least one ejection drive element in the inspection zone, the generation unit generates the circulation data such that the plurality of circulation drive elements corresponding to the plurality of ejection drive elements belonging to the certain one of the groups drive the plurality of circulation energy generation elements corresponding to the plurality of circulation drive elements in the drive zone.

5. The liquid ejection apparatus according to claim 4, wherein
in a case where all of the plurality of ejection drive elements belonging to a certain one of the groups drive the plurality of ejection energy generation elements corresponding to all of the plurality of ejection drive elements in the inspection zone, the generation unit generates the circulation data such that the plurality of circulation drive elements corresponding to the plurality of ejection drive elements belonging to the certain one of the groups do not drive the plurality of circulation energy generation elements corresponding to the plurality of circulation drive elements in the drive zone.

6. The liquid ejection apparatus according to claim 5, wherein
after generating the circulation data such that the plurality of circulation drive elements corresponding to the plurality of ejection drive elements belonging to the certain one of the groups do not drive the plurality of circulation energy generation elements corresponding to the plurality of circulation drive elements in the drive zone, the generation unit shifts the inspection zone so that a next inspection zone is shifted by one column from the current inspection zone.

7. The liquid ejection apparatus according to claim 4, wherein
the at least one ejection drive element is any one of the plurality of ejection drive elements.

8. The liquid ejection apparatus according to claim 4, wherein
the at least one ejection drive element is all of the plurality of ejection drive elements.

9. The liquid ejection apparatus according to claim 4, wherein
the at least one ejection drive element is two or more of the plurality of ejection drive elements.

10. The liquid ejection apparatus according to claim 4, wherein
after generating the circulation data such that the plurality of circulation drive elements corresponding to the plurality of ejection drive elements belonging to the certain one of the groups drive the plurality of circulation energy generation elements corresponding to the plurality of circulation drive elements in the drive zone, the generation unit shifts the inspection zone so that a start position of a next inspection zone is anywhere between a start position and an end position of the current drive zone.

11. The liquid ejection apparatus according to claim 1, wherein
after generating the circulation data such that the circulation drive element corresponding to the certain one of the ejection drive elements drives the circulation energy generation element corresponding to the circulation drive element in the drive zone included in the inspection zone, the generation unit shifts the inspection zone so that a start position of a next inspection zone is at an end position of the current drive zone.

12. The liquid ejection apparatus according to claim 1, wherein
after generating the circulation data such that the circulation drive element corresponding to the certain one of the ejection drive elements does not drive the circulation energy generation element corresponding to the circulation drive element in the drive zone included in the inspection zone, the generation unit shifts the inspection zone so that a next inspection zone is shifted by one column from the current inspection zone.

13. The liquid ejection apparatus according to claim 1, wherein
a first non-drive zone is provided between a start position of the inspection zone and a start position of the drive zone.

14. The liquid ejection apparatus according to claim 1, wherein
a second non-drive zone is provided between an end position of the inspection zone and an end position of the drive zone.

15. The liquid ejection apparatus according to claim 1, wherein
the liquid ejection head control unit further comprises a unit configured to make an adjustment in a case where the ejection data and the circulation data indicate that a certain one of the ejection energy generation elements and the circulation drive element corresponding to the certain one of the ejection energy generation elements are both driven simultaneously, the adjustment being to drive the certain one of the ejection energy generation elements and not to drive the circulation drive element corresponding to the certain one of the ejection energy generation elements.

16. The liquid ejection apparatus according to claim 1, wherein
the circulation drive elements and the circulation energy generation elements corresponding to the circulation drive elements are provided for the respective pressure chambers.

17. A liquid ejection head control device for controlling a liquid ejection head configured to eject liquid to a printing medium, the liquid ejection head control apparatus including
the liquid ejection head configured to eject the liquid to the printing medium along a scanning direction and
a liquid ejection head control unit configured to control the liquid ejection head, wherein
the liquid ejection head comprises:
a plurality of ejection ports through which the liquid is ejected;
a plurality of pressure chambers communicating with the plurality of respective ejection ports;
a plurality of ejection energy generation elements each configured to generate energy for ejecting the liquid in a corresponding one of the plurality of pressure chambers through a corresponding one of the plurality of ejection ports;
a plurality of circulation energy generation elements each configured to generate energy for circulating the liquid in a corresponding one of the plurality of pressure chambers through a flow channel inside the liquid ejection head;
a plurality of ejection drive elements each configured to drive a corresponding one of the plurality of ejection energy generation elements based on
the liquid ejection head control unit comprises:
a unit configured to generate the ejection data based on image data; and
a generation unit configured to generate the circulation data based on the ejection data, the circulation data being such that in a case where a certain one of the ejection drive elements does not drive the ejection energy generation element corresponding to the certain one of the ejection drive elements within an inspection zone defined in the ejection data and shifted in the scanning direction, the circulation drive element corresponding to the certain one of the ejection drive elements drives the circulation energy generation element corresponding to the circulation drive element in a drive zone included in the inspection zone.

18. A liquid ejection head control method for controlling a liquid ejection head configured to eject liquid to a printing medium, wherein
the liquid ejection head comprises:
a plurality of ejection ports through which the liquid is ejected;
a plurality of pressure chambers communicating with the plurality of respective ejection ports;
a plurality of ejection energy generation elements each configured to generate energy for ejecting the liquid in a corresponding one of the plurality of pressure chambers through a corresponding one of the plurality of ejection ports;
a plurality of circulation energy generation elements each configured to generate energy for circulating the liquid in a corresponding one of the plurality of pressure chambers through a flow channel inside the liquid ejection head;
a plurality of ejection drive elements each configured to drive a corresponding one of the plurality of ejection energy generation elements based on
the liquid ejection head control method comprises:
generating the ejection data based on image data; and
generating the circulation data based on the ejection data, the circulation data being such that in a case where a certain one of the ejection drive elements does not drive the ejection energy generation element corresponding to the certain one of the ejection drive elements within an inspection zone defined in the ejection data and shifted in the scanning direction, the circulation drive element corresponding to the certain one of the ejection drive elements drives the circulation energy generation element corresponding to the circulation drive element in a drive zone included in the inspection zone.
